(19) United States
(12) Patent Application Publication
(10) Pub. No.: US 2016/0373767 A1
(43) Pub. Date: Dec. 22, 2016

(54) Encoding and Decoding Methods and Apparatuses

(71) Applicant: Huawei Technologies Co., Ltd., Shenzhen (CN)

(72) Inventors: Haitao Yang, Shenzhen (CN); Amin Zheng, Hong Kong (HK); Yuan Yuan, Hong Kong (HK); Oscar Au, Hong Kong (HK)

(21) Appl. No.: 15/240,436

(22) Filed: Aug. 18, 2016

Related U.S. Application Data
(63) Continuation of application No. PCT/CN2015/072089, filed on Feb. 2, 2015.

(30) Foreign Application Priority Data
Feb. 18, 2014 (CN) 201410054130.3

(51) Int. Cl. H04N 19/174; H04N 19/184; H04N 19/593; H04N 19/129; H04N 19/146

(52) U.S. Cl. CPC H04N 19/174; H04N 19/129; H04N 19/146; H04N 19/593; H04N 19/184

(57) ABSTRACT

Encoding and decoding methods and apparatuses, which can fully utilize a spatial correlation in video information, thereby improving compression efficiency during encoding and decoding where the method includes determining, according to a total coding cost of a target image, a first processing order of multiple code blocks groups included in the target image, encoding a code blocks group of the multiple code blocks groups according to the first processing order, to generate a bitstream, and writing the first processing order to the bitstream. A first processing order of multiple code blocks groups included in a target image is determined according to a total coding cost of the target image, and the multiple code blocks groups are encoded and decoded according to the first processing order such that a spatial correlation in video information may be fully utilized, thereby improving compression efficiency during encoding and decoding.

### CROSS-REFERENCE TO RELATED APPLICATIONS

This application is a continuation of International Application No. PCT/CN2015/072089, filed on Feb. 2, 2015, which claims priority to Chinese Patent Application No. 201410054130.3, filed on Feb. 18, 2014, both of which are hereby incorporated by reference in their entireties.

### TECHNICAL FIELD

The present disclosure relates to the field of image processing, and in particular, to encoding and decoding methods and apparatuses.

### BACKGROUND

Video compression coding technologies are widely used in the fields of multimedia services, broadcast communications, video communications, storage, and the like. The H.264 standard and the advanced video coding (AVC) standard that are jointly developed by the International Telecommunication Union-Telecommunication Standardization Sector (ITU-T) and the International Organization for Standardization (ISO)/International Electrotechnical Commission (IEC) are the most widely used video coding standards today. However, the H.264/AVC is not applicable to compression coding of a high resolution video. As people have increasing demands for high-definition, ultra high definition, and three dimensional (3D) videos, the Joint Collaborative Team on Video Coding (JCT-VC) puts forward the High Efficiency Video Coding (HEVC) standard, and compared with the H.264/AVC, compression efficiency of the HEVC is improved by approximately 50%.

In the HEVC standard, a to-be-encoded image is divided into non-overlapping image blocks. An encoder performs progressive scanning to sequentially process each image block. The foregoing image block may be further divided into multiple subblocks, and coding parameters of each subblock may be independently determined for each subblock. In HEVC terminologies, the foregoing non-overlapping image blocks are referred to as coding tree units (CTUs), and a size of the CTU is generally set to 64×64 pixels. A quadtree structure may be used to further divide the CTU into multiple subblocks, where the subblock is generally referred to as a code unit (CU) in the HEVC. CUs in one CTU are encoded in an order of scanning in a Z-shaped manner, and all CTUs in one frame are encoded in an order of line scan. An intra-frame prediction mode in the HEVC includes direct current prediction, plane prediction, and directional prediction. For a to-be-encoded block, code blocks that are already reconstructed on the left of and above the to-be-encoded block are used as references for prediction, and a pixel used for prediction in the block that is already reconstructed is referred to as a reference pixel. The direct current prediction is applicable to a block in an area with flat textures in the image, and for all pixels in the block, an average value of the reference pixel is used as a predictor. In the plane prediction, the reference pixel is used to go through a bilinear interpolation operation to obtain predictors of all pixels in a block, and therefore, the plane prediction is applicable to a block with smoothly changing textures. In the directional prediction, a feature that textures included in a current code block are highly related to a block that is already reconstructed and close to the current code block is used, and along a given direction a value of a corresponding reference pixel is duplicated as a predictor of a pixel in the current block.

In the H.264/AVC standard, a code block is referred to as a macroblock (MB), a size of the macroblock is fixedly 16×16 pixels, and each macroblock can be divided into only 4×4, 8×8, or 16×16 sub macroblocks (SMB) for predictive coding. The MB and the SMB respectively correspond to a CTU and a CU in the HEVC. An encoding order of MBs is similar to that of CTUs, and both the MBs and the CTUs are encoded in an order of line scan, and an encoding order of SMBs is also progressive scanning in a Z-shaped manner. Intra-frame prediction in the H.264/AVC also uses mean prediction and directional prediction, but there is a maximum of nine prediction modes.

That is, a to-be-encoded image is first divided into non-overlapping code blocks, and then each block is sequentially encoded in a fixed order (an order of line scan) when an image is encoded in a traditional video coding standard, which results in relatively low encoding compression efficiency.

### SUMMARY

Embodiments of the present disclosure provide encoding and decoding methods and apparatuses, which can fully utilize a spatial correlation in video information, thereby improving compression efficiency during encoding and decoding.

According to a first aspect, an encoding method is provided, including determining, according to a total coding cost of a target image, a first processing order of multiple code blocks groups included in the target image, encoding a code blocks group of the multiple code blocks groups according to the first processing order, to generate a bitstream, and writing the first processing order to the bitstream.

With reference to the first aspect, in a first implementation manner of the first aspect, determining, according to a total coding cost of a target image, a first processing order of multiple code blocks groups included in the target image includes determining a total coding cost corresponding to each processing order of all processing orders of the multiple code blocks groups, where the total coding cost corresponding to each processing order is a sum of coding costs when the multiple code blocks groups are encoded according to each processing order, and determining that a processing order corresponding to a minimum total coding cost of the total coding costs corresponding to all the processing orders is the first processing order.

With reference to the first aspect and the foregoing implementation manner of the first aspect, in a second implementation manner of the first aspect, encoding a code blocks group of the multiple code blocks groups according to the first processing order, to generate a bitstream includes determining, according to the first processing order, a processing order of multiple code blocks included in the code blocks group, and encoding the code blocks group according to the first processing order and the processing order of the multiple code blocks included in the code blocks group.

With reference to the first aspect and the foregoing implementation manner of the first aspect, in a third implementation manner of the first aspect, before determining, according to the first processing order, a processing order of multiple code blocks included in the code blocks group, the method further includes determining multiple candidate processing orders of the code blocks, and determining a correspondence between the multiple candidate processing orders and multiple location relationships, where the multiple location relationships are multiple relative location relationships between a currently processed code blocks group and a code blocks group that is already processed and that is adjacent to the currently processed code blocks group.

With reference to the first aspect and the foregoing implementation manner of the first aspect, in a fourth implementation manner of the first aspect, determining, according to the first processing order, a processing order of multiple code blocks included in the code blocks group includes determining, according to the first processing order, a relative location relationship between the code blocks group and a code blocks group that is already processed and that is adjacent to the code blocks group, and determining, according to the correspondence and the relative location relationship, the processing order of the multiple code blocks included in the code blocks group.

With reference to the first aspect and the foregoing implementation manner of the first aspect, in a fifth implementation manner of the first aspect, determining multiple candidate processing orders of the code blocks includes using preset multiple candidate processing orders of the code blocks.

With reference to the first aspect and the foregoing implementation manner of the first aspect, in a sixth implementation manner of the first aspect, determining, according to the first processing order, a processing order of multiple code blocks included in the code blocks group includes determining, according to the first processing order, a relative location relationship between the code blocks group and a code blocks group that is already processed and that is adjacent to the code blocks group, and determining, according to the relative location relationship and a correspondence between the preset multiple candidate processing orders and the multiple location relationships, the processing order of the multiple code blocks included in the code blocks group, where the multiple location relationships are multiple relative location relationships between a currently processed code blocks group and a code blocks group that is already processed and that is adjacent to the currently processed code blocks group.

With reference to the first aspect and the foregoing implementation manner of the first aspect, in a seventh implementation manner of the first aspect, writing the first processing order to the bitstream includes arranging indexes of the code blocks group according to the first processing order, encoding the arranged indexes of the code blocks group and writing the encoded indexes to the bitstream, or arranging coordinates of the code blocks group according to the first processing order, and encoding the arranged coordinates of the code blocks group and writing the encoded coordinates to the bitstream.

With reference to the first aspect and the foregoing implementation manners of the first aspect, in an eighth implementation manner of the first aspect, a coding cost of the code blocks group includes at least one of a quantity of bits consumed to encode the code blocks group, or distortion of the code blocks group.

According to a second aspect, a decoding method is provided, including acquiring a first processing order of multiple code blocks groups of a target image from a bitstream, determining, according to the first processing order, a processing order of multiple code blocks included in a code blocks group of the multiple code blocks groups, and decoding the bitstream according to the first processing order and the processing order of the multiple code blocks included in the code blocks group.

With reference to the second aspect, in a first implementation manner of the second aspect, before determining, according to the first processing order, a processing order of multiple code blocks included in a code blocks group of the multiple code blocks groups, the method further includes determining multiple candidate processing orders of the code blocks, and determining a correspondence between the multiple candidate processing orders and multiple location relationships, where the multiple location relationships are multiple relative location relationships between a currently processed code blocks group and a code blocks group that is already processed and that is adjacent to the currently processed code blocks group.

With reference to the second aspect and the foregoing implementation manner of the second aspect, in a second implementation manner of the second aspect, determining, according to the first processing order, a processing order of multiple code blocks included in a code blocks group of the multiple code blocks groups includes determining, according to the first processing order, a relative location relationship between the code blocks group and a code blocks group that is already processed and that is adjacent to the code blocks group, and determining, according to the correspondence and the relative location relationship, the processing order of the multiple code blocks included in the code blocks group.

With reference to the second aspect and the foregoing implementation manner of the second aspect, in a third implementation manner of the second aspect, determining multiple candidate processing orders of the code blocks includes using preset multiple candidate processing orders of the code blocks.

With reference to the second aspect and the foregoing implementation manner of the second aspect, in a fourth implementation manner of the second aspect, determining, according to the first processing order, a processing order of multiple code blocks included in the code blocks group includes determining, according to the first processing order, a relative location relationship between the code blocks group and a code blocks group that is already processed and that is adjacent to the code blocks group, and determining, according to the relative location relationship and a correspondence between the preset multiple candidate processing orders and the multiple location relationships, the processing order of the multiple code blocks included in the code blocks group, where the multiple location relationships are multiple relative location relationships between a currently processed code blocks group and a code blocks group that is already processed and that is adjacent to the currently processed code blocks group.

With reference to the second aspect and the foregoing implementation manner of the second aspect, in a fifth implementation manner of the second aspect, acquiring a first processing order of multiple code blocks groups of a target image from a bitstream includes decoding the bitstream to obtain arranged indexes of the multiple code blocks groups, and determining the first processing order according to an arrangement order of the indexes of the multiple code blocks groups, or decoding the bitstream to obtain arranged coordinates of the multiple code blocks groups, and determining the first processing order according to an arrangement order of the coordinates of the multiple code blocks groups.

According to a third aspect, an encoder is provided, including a determining unit configured to determine, according to a total coding cost of a target image, a first processing order of multiple code blocks groups included in the target image, and an encoding unit configured to encode a code blocks group of the multiple code blocks groups according to the first processing order determined by the determining unit, to generate a bitstream, where the encoding unit is further configured to write the first processing order determined by the determining unit to the bitstream.

With reference to the third aspect, in a first implementation manner of the third aspect, the determining unit is further configured to determine a total coding cost corresponding to each processing order of all processing orders of the multiple code blocks groups, where the total coding cost corresponding to each processing order is a sum of coding costs when the multiple code blocks groups are encoded according to each processing order, and determine that a processing order corresponding to a minimum total coding cost of the total coding costs corresponding to all the processing orders is the first processing order.

With reference to the third aspect and the foregoing implementation manner of the third aspect, in a second implementation manner of the third aspect, the encoding unit is further configured to determine, according to the first processing order using the determining unit, a processing order of multiple code blocks included in the code blocks group, and encode the code blocks group according to the first processing order and the processing order of the multiple code blocks included in the code blocks group.

With reference to the third aspect and the foregoing implementation manner of the third aspect, in a third implementation manner of the third aspect, the determining unit is further configured to determine multiple candidate processing orders of the code blocks, and determine a correspondence between the multiple candidate processing orders and multiple location relationships, where the multiple location relationships are multiple relative location relationships between a currently processed code blocks group and a code blocks group that is already processed and that is adjacent to the currently processed code blocks group.

With reference to the third aspect and the foregoing implementation manner of the third aspect, in a fourth implementation manner of the third aspect, the determining unit is further configured to determine, according to the first processing order, a relative location relationship between the code blocks group and a code blocks group that is already processed and that is adjacent to the code blocks group, and determine, according to the correspondence and the relative location relationship, the processing order of the multiple code blocks included in the code blocks group.

With reference to the third aspect and the foregoing implementation manner of the third aspect, in a fifth implementation manner of the third aspect, the determining unit is further configured to use preset multiple candidate processing orders of the code blocks.

With reference to the third aspect and the foregoing implementation manner of the third aspect, in a sixth implementation manner of the third aspect, the determining unit is further configured to determine, according to the first processing order, a relative location relationship between the code blocks group and a code blocks group that is already processed and that is adjacent to the code blocks group, and determine, according to the relative location relationship and a correspondence between the preset multiple candidate processing orders and the multiple location relationships, the processing order of the multiple code blocks included in the code blocks group, where the multiple location relationships are multiple relative location relationships between a currently processed code blocks group and a code blocks group that is already processed and that is adjacent to the currently processed code blocks group.

With reference to the third aspect and the foregoing implementation manner of the third aspect, in a seventh implementation manner of the third aspect, the encoding unit is further configured to arrange indexes of the code blocks group according to the first processing order, and encode the arranged indexes of the code blocks group and write the encoded indexes to the bitstream, or arrange coordinates of the code blocks group according to the first processing order, and encode the arranged coordinates of the code blocks group and write the encoded coordinates to the bitstream.

With reference to the third aspect and the foregoing implementation manners of the third aspect, in an eighth implementation manner of the third aspect, a coding cost of the code blocks group includes at least one of a quantity of bits consumed by the encoding unit to encode the code blocks group, or distortion of the code blocks group.

According to a fourth aspect, a decoder is provided, including an acquiring unit configured to acquire a first processing order of multiple code blocks groups of a target image from a bitstream, a determining unit configured to determine, according to the first processing order, a processing order of multiple code blocks included in a code blocks group of the multiple code blocks groups, and a decoding unit configured to decode the bitstream according to the first processing order and the processing order of the multiple code blocks included in the code blocks group.

With reference to the fourth aspect, in a first implementation manner of the fourth aspect, the determining unit is further configured to determine multiple candidate processing orders of the code blocks, and determine a correspondence between the multiple candidate processing orders and multiple location relationships, where the multiple location relationships are multiple relative location relationships between a currently processed code blocks group and a code blocks group that is already processed and that is adjacent to the currently processed code blocks group.

With reference to the fourth aspect and the foregoing implementation manner of the fourth aspect, in a second implementation manner of the fourth aspect, the determining unit is further configured to determine, according to the first processing order, a relative location relationship between the code blocks group and a code blocks group that is already processed and that is adjacent to the code blocks group, and determine, according to the correspondence and the relative location relationship, the processing order of the multiple code blocks included in the code blocks group.

With reference to the fourth aspect and the foregoing implementation manner of the fourth aspect, in a third implementation manner of the fourth aspect, the determining unit is further configured to use preset multiple candidate processing orders of the code blocks.

With reference to the fourth aspect and the foregoing implementation manner of the fourth aspect, in a fourth implementation manner of the fourth aspect, the determining unit is further configured to determine, according to the first processing order, a relative location relationship between the code blocks group and a code blocks group that is already processed and that is adjacent to the code blocks group, and determine, according to the relative location relationship and a correspondence between the preset multiple candidate processing orders and the multiple location relationships, the processing order of the multiple code blocks included in the code blocks group, where the multiple location relationships are multiple relative location relationships between a currently processed code blocks group and a code blocks group that is already processed and that is adjacent to the currently processed code blocks group.

With reference to the fourth aspect and the foregoing implementation manner of the fourth aspect, in a fifth implementation manner of the fourth aspect, the acquiring unit is further configured to use the decoding unit to decode the bitstream to obtain arranged indexes of the multiple code blocks groups, use the determining unit to determine the first processing order according to an arrangement order of the indexes of the multiple code blocks groups, or use the decoding unit to decode the bitstream to obtain arranged coordinates of the multiple code blocks groups, and use the determining unit to determine the first processing order according to an arrangement order of the coordinates of the multiple code blocks groups.

In the embodiments of the present disclosure, a first processing order of multiple code blocks groups included in a target image is determined according to a total coding cost of the target image, and the multiple code blocks groups are encoded and decoded according to the first processing order such that a spatial correlation in video information can be fully utilized, thereby improving compression efficiency during encoding and decoding.

### BRIEF DESCRIPTION OF DRAWINGS

To describe the technical solutions in the embodiments of the present disclosure more clearly, the following briefly introduces the accompanying drawings required for describing the embodiments of the present disclosure. The accompanying drawings in the following description show merely some embodiments of the present disclosure, and a person of ordinary skill in the art may still derive other drawings from these accompanying drawings without creative efforts.

FIG. 1 is a flowchart of an encoding method according to an embodiment of the present disclosure;

FIG. 2 is a flowchart of a decoding method according to an embodiment of the present disclosure;

FIG. 3 is a schematic diagram of a processing order of code blocks according to an embodiment of the present disclosure;

FIG. 4 is a schematic diagram of a processing order of code blocks according to another embodiment of the present disclosure;

FIG. 5 is a schematic diagram of a correspondence between candidate processing orders of code blocks and multiple location relationships according to an embodiment of the present disclosure;

FIG. 6 is a flowchart of encoding on an encoder side according to an embodiment of the present disclosure;

FIG. 7 is a flowchart of decoding on a decoder side according to an embodiment of the present disclosure;

FIG. 8 is a schematic block diagram of an encoder according to an embodiment of the present disclosure;

FIG. 9 is a schematic block diagram of a decoder according to an embodiment of the present disclosure;

FIG. 10 is a schematic block diagram of an encoder according to another embodiment of the present disclosure; and

FIG. 11 is a schematic block diagram of a decoder according to another embodiment of the present disclosure.

### DESCRIPTION OF EMBODIMENTS

The following clearly describes the technical solutions in the embodiments of the present disclosure with reference to the accompanying drawings in the embodiments of the present disclosure. The described embodiments are some but not all of the embodiments of the present disclosure. All other embodiments obtained by a person of ordinary skill in the art based on the embodiments of the present disclosure without creative efforts shall fall within the protection scope of the present disclosure.

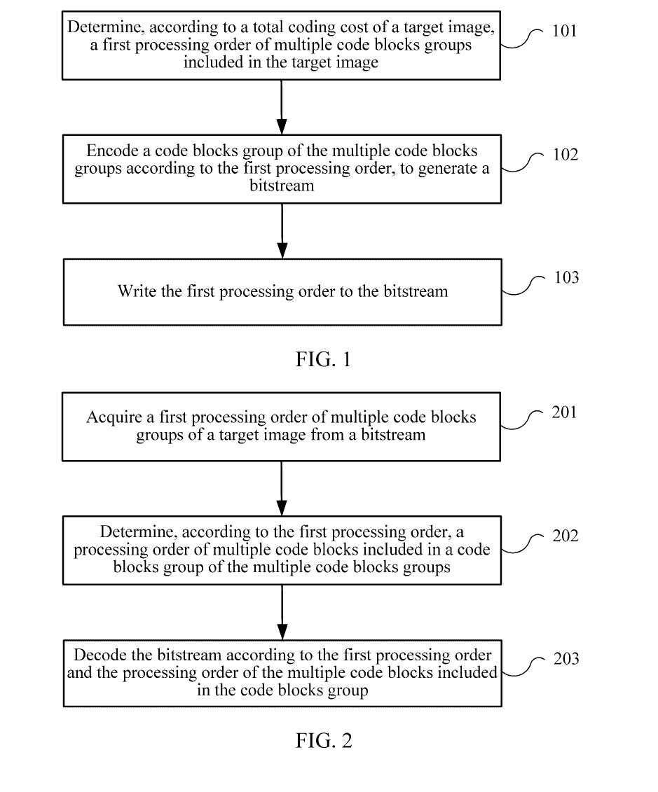

FIG. 1 is a flowchart of an encoding method according to an embodiment of the present disclosure, and the method may include the following steps.

Step 101: Determine, according to a total coding cost of a target image, a first processing order of multiple code blocks groups included in the target image.

Step 102: Encode a code blocks group of the multiple code blocks groups according to the first processing order, to generate a bitstream.

Step 103: Write the first processing order to the bitstream.

In this embodiment of the present disclosure, a first processing order of multiple code blocks groups included in a target image is determined according to a total coding cost of the target image, and the multiple code blocks groups are encoded according to the first processing order such that a spatial correlation in the target image can be fully utilized, thereby improving compression efficiency during encoding.

It should be understood that, the target image in this embodiment of the present disclosure is a to-be-encoded image, or may be referred to as a coded image. The target image is divided into multiple non-overlapping code blocks groups, where the code blocks group may be equivalent to a CTU in the HEVC, or may be equivalent to a MB in the H.264/AVC, or the like. The code blocks group may continue to be divided into multiple code blocks for which coding parameters can be independently determined, where the code block may be equivalent to a CU in the HEVC, or may be equivalent to a SMB in the H.264/AVC, or the like.

Optionally, in an embodiment, step 101 may include determining a total coding cost corresponding to each processing order of all processing orders of the multiple code blocks groups, where the total coding cost corresponding to each processing order is a sum of coding costs when the multiple code blocks groups are encoded according to each processing order, and determining that a processing order corresponding to a minimum total coding cost of the total coding costs corresponding to all the processing orders is the first processing order.

Furthermore, a coding cost of each code blocks group varies with the processing order when code blocks groups are processed in different processing orders. The coding cost of the code blocks group is an important criterion for measuring quality of encoding of the blocks group. A quantity of bits consumed to encode the block and quality of the block after reconstruction are determined when a coding cost is calculated. A smaller value of the coding cost indicates better encoding of the block. Therefore, a processing order that can achieve a minimum total coding cost of all code blocks groups may be used as an optimum processing order. Therefore, a question of determining an optimum processing order may be converted into a question of solving a minimum total coding cost:

$$J ( {O}_{{S}_{N}} ) = min DP ( {S}_{N} , {O}_{{S}_{N}} ) = min {\sum }_{j = 1 , j ∈ \{ 1 \leq i \leq N , i ∉ {S}_{j , k} \}}^{N} RD ( {S}_{j , k} , i ) , \qquad ( 1 )$$

where N indicates a total quantity of code blocks groups,1≦i≦N represents that indexes of the code blocks groups are indicated in a left-to-right top-to-bottom order, O is a vector indicating a processing order of the code blocks groups, each item of O is an arrangement manner of indexes of the code blocks groups, total possible processing orders are a permutation N! of N, a processing order indicated when O=[1,2, . . . , N] is a traditional line scan processing order, S_{j,k} is a set, including indexes of j blocks groups that are already processed, k indicates that the j blocks group that are already processed is the k^{th} combination of Cₙ^{j} possible combinations of j blocks groups selected from the N blocks groups, i indicates one of blocks groups that are not encoded, RD(S_{j,k},i) indicates a cost required for processing a code blocks group i in a case in which all code blocks groups in S_{j,k} have been processed, S_{N} indicates a set of all N code blocks groups, O_{S}_{_{N}} indicates an optimum processing order of the N code blocks groups, and an objective of the optimum question is to find a processing order O_{S}_{_{N}} such that a total cost DP(S_{N}, O_{S}_{_{N}}) of all the N code blocks groups is the minimum.

To solve J(O_{S}_{_{N}}) , a cost RD(S_{j,k},i) of each code blocks group needs to be calculated. After a cost RD(S_{j,k},i) of one code blocks group is obtained, a method described in a formula (2) may be used to determine an optimum processing order of the code blocks groups:

$$DP ( {S}_{j + 1 , k} , {O}_{{S}_{j , k}} ) = {min}_{i ∈ \{ 1 \leq i \leq N , i ∉ {S}_{j , k} \}} \{ DP ( {S}_{j , k} , {O}_{{S}_{j , k}} ) + RD ( {S}_{j , k} , i ) \} , \qquad ( 2 )$$

where j,1≦j≦N−1 indicates a quantity of code blocks groups that are already processed, k,1≦k≦C_{N}^{k} indicates the k^{th} combination of all possible combinations of the j blocks groups that are already processed, S_{j,k} is a set, including indexes of the j blocking groups that are already processed in the foregoing case of the k^{th} combination, a cost function DP(S_{j,k}, O_{S}_{_{j,k}}) indicates a sum of costs of all blocking groups in a code blocks group set S_{j,k}, that is, a total cost required to process, using the optimum processing order O_{S}_{_{j,k}}, the j code blocks groups included in S_{j,k}, and RD(S_{j,k},i) indicates a cost caused when the blocking group i is encoded in a case in which all the j blocks groups indicated by the k^{th} combination indicated by S_{j,k} have been processed.

An example is provided for describing the foregoing process, where there are three code blocks groups numbered 1, 2, and 3 to be processed. There are three possible cases for S_{j,k} when j=2, that is, S_{j,k}={1,2}, S_{j,k}={1,3}, and S_{j,k}={2,3}, optimum encoding orders thereof are O_{{1,2}}=1,2, O_{{1,3}}=3,1, and O_{{2,3}}=3,2, and optimum costs corresponding thereto are DP({1,2}, O_{{1,2}}) , DP({1,3}, O_{{1,3}}), and DP({2,3}, O_{{2,3}}). Further, a case in which j=3 is considered. In the three possible cases for S_{j,k}, other code blocks groups are respectively a blocking group numbered 3, a blocking group numbered 2, and a blocking group numbered 1, and corresponding costs for encoding the blocking groups are respectively RD({1,2},3), RD({1,3},2), and RD({2,3},1). In this case, a minimum cost DP({1,2,3}, O_{{1,2,3}}) of the three code blocks groups with encoding numbers 1, 2, and 3 may be obtained by means of calculation using a formula (3), and subsequently, an optimum processing order O_{{1,2,3}} is determined. Formula (3) will be as follows:

$$DP ( \{ 1 , 2 , 3 \} , {O}_{\{ 1 , 2 , 3 \}} ) = min \{ \begin{matrix}DP ( \{ 2 , 3 \} , {O}_{\{ 2 , 3 \}} ) + RD ( \{ 2 , 3 \} , 1 ) , \\ DP ( \{ 1 , 2 \} , {O}_{\{ 1 , 2 \}} ) + RD ( \{ 1 , 2 \} , 3 ) , \\ DP ( \{ 1 , 3 \} , {O}_{\{ 1 , 3 \}} ) + RD ( \{ 1 , 3 \} , 2 ) .\end{matrix} \} . \qquad ( 3 )$$

Optionally, in an embodiment, step 102 includes determining, according to the first processing order, a processing order of multiple code blocks included in the code blocks group, and encoding the code blocks group according to the first processing order and the processing order of the multiple code blocks included in the code blocks group.

The processing order of the code blocks included in the code blocks group may further need to be determined after the processing order of the code blocks groups is determined. A processing order of code blocks in a current code blocks group may be determined according to the processing order of the code blocks groups. That is, a processing order between the current code blocks group and a code blocks group adjacent to the current code blocks group may be determined according to the processing order of the code blocks groups such that the processing order of the code blocks in the current code blocks group is determined. The code blocks in the current code blocks group may have multiple preset candidate processing orders, where each candidate processing order corresponds to one location relationship, and the location relationship is a relative location relationship between a currently processed code blocks group and a code blocks group that is already processed and that is adjacent to the currently processed code blocks group. A relative location relationship between the current code blocks group and a code blocks group that is already encoded and that is adjacent or close to the current code blocks group may be first determined when the current code blocks group is to be encoded, and then a processing order of code blocks in a corresponding code blocks group is determined in a preconfigured correspondence according to the determined relative location relationship. All code blocks in the current code blocks group are encoded according to the processing order after the processing order of the code blocks is determined, and a next code blocks group is processed according to the first processing order after the encoding is finished. Similar to the current code blocks group, a processing order of code blocks in the next code blocks group needs to be determined according to a relative location relationship, and so on, until all code blocks groups of the target image are completely encoded according to the first processing order.

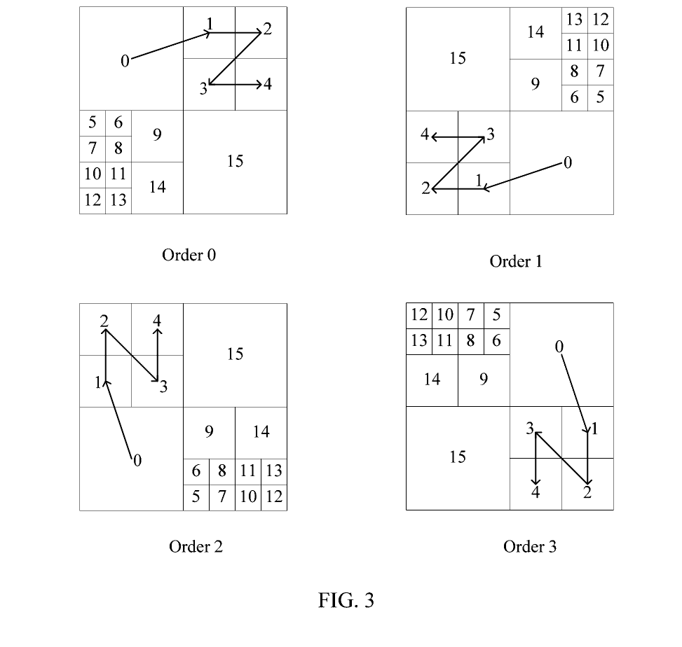

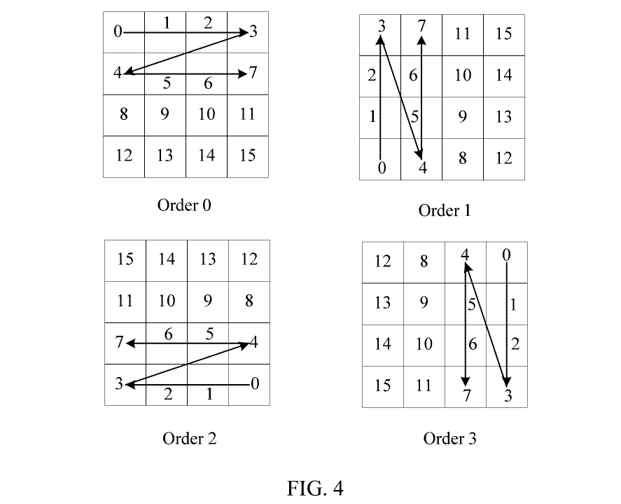

Optionally, in an embodiment, before determining, according to the first processing order, a processing order of multiple code blocks included in each code blocks group of the code blocks groups, the method further includes determining multiple candidate processing orders of the code blocks, and determining a correspondence between the multiple candidate processing orders and multiple location relationships, where the multiple location relationships are multiple relative location relationships between a currently processed code blocks group and a code blocks group that is already processed and that is adjacent to the currently processed code blocks group. Optionally, in an embodiment, determining multiple candidate processing orders of the code blocks includes using preset multiple candidate processing orders of the code blocks. The preset multiple candidate processing orders of the code blocks may be determined using multiple methods. For example, the preset multiple candidate processing orders of the code blocks are determined according to a division manner of the code blocks included in the code blocks group. The division manner of the code blocks may include equal-size division, that is, sizes of the code blocks in the code blocks group are equal, which is used, for example, in the H.264/AVC. The division manner of the code blocks may further include non-equal-size division, for example, in the HEVC. In a case of equal-size division, the preset multiple candidate processing orders of the code blocks may be shown in FIG. 4. In a case of non-equal-size division, the preset multiple candidate processing orders of the code blocks may be shown in FIG. 3. It should be understood that the several processing orders shown in FIG. 3 and FIG. 4 are only some examples, and a preset processing order of code blocks is not limited thereto, and may be any order.

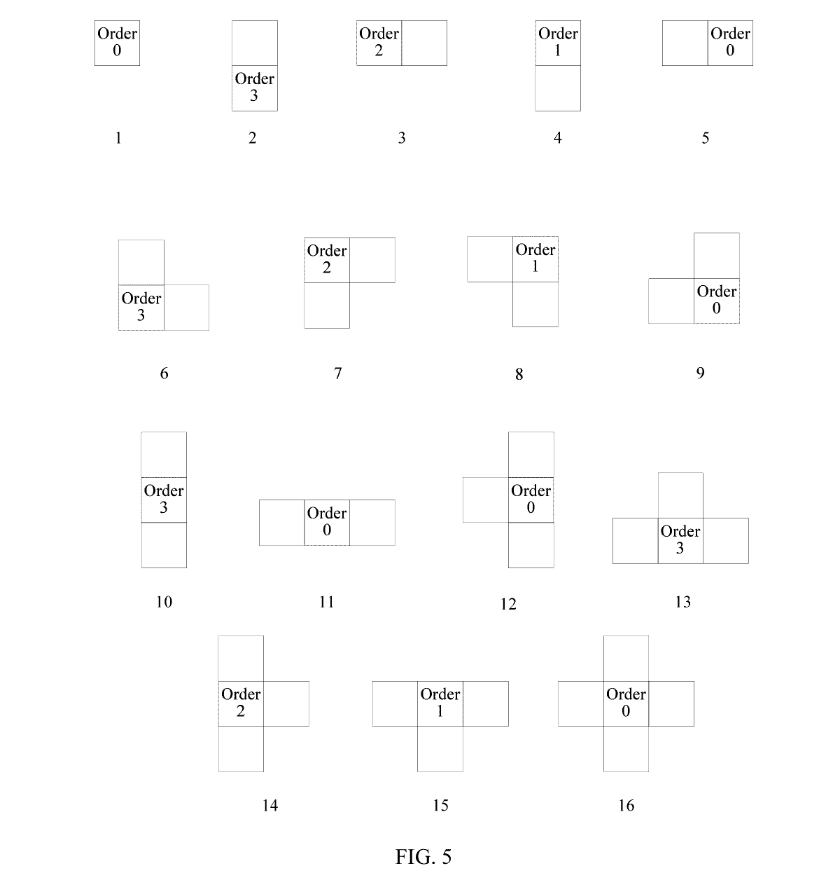

For example, an encoder side may preset a correspondence between multiple processing orders of the code blocks in the code blocks group, and relative locations of the code blocks group and a code blocks group that is already encoded. For example, four processing orders of code blocks shown in FIG. 4 may be preset, where an order 0 is progressive scanning from left to right, an order 2 is progressive scanning from right to left, an order 3 is column-by-column scanning from top to bottom, and an order 1 is column-by-column scanning from bottom to top. The relative locations of the code blocks group and the code blocks group that is already encoded may be 16 relative locations shown in FIG. 5:

1. There is no code blocks group that is already encoded and that is adjacent to the code blocks group.

2. A code blocks group above the code blocks group has been encoded.

3. A code blocks group on the right of the code blocks group has been encoded.

4. A code blocks group below the code blocks group has been encoded.

5. A code blocks group on the left of the code blocks group has been encoded.

6. Code blocks groups above and on the right of the code blocks group have been encoded.

7. Code blocks groups below and on the right of the code blocks group have been encoded.

8. Code blocks groups on the left of and below the code blocks group have been encoded.

9. Code blocks groups on the left of and above the code blocks group have been encoded.

10. Code blocks groups above and below the code blocks group have been encoded.

11. Code blocks groups on the left and on the right of the code blocks group have been encoded.

12. Code blocks groups above, below, and on the left of the code blocks group have been encoded.

13. Code blocks groups on the left of, on the right of, and above the code blocks group have been encoded.

14. Code blocks groups above, below, and on the right of the code blocks group have been encoded.

15. Code blocks groups on the left of, on the right of, and below the code blocks group have been encoded.

16. Code blocks groups above, below, on the left of, and on the right of the code blocks group have been encoded.

The encoder side may further preconfigure a correspondence between the foregoing four processing orders and the foregoing 16 relative location relationships. For example, a relative location relationship 1 corresponds to the order 0, a relative location relationship 2 corresponds to the order 3, and a relative location relationship 3 corresponds to the order 2.

It can be learned from the foregoing correspondence that, a corresponding case is selected from the foregoing 16 cases for the current code blocks group when a different code blocks group processing order is given. A processing order of code blocks in the current code blocks group is subsequently determined, then an encoding operation is performed on the code blocks in the current code blocks group according to the given code block processing order, and a coding cost is calculated.

Herein, for the determining of the code block processing order, a pixel value in the current code blocks group is predicted using as much as possible a pixel value in an adjacent code blocks group that is already processed. A spatial correlation of a coded image is relatively fully considered, which helps improve compression efficiency.

Optionally, in an embodiment, determining, according to the first processing order, a processing order of multiple code blocks included in the code blocks group includes determining, according to the first processing order, a relative location relationship between the code blocks group and a code blocks group that is already processed and that is adjacent to the code blocks group, and determining, according to the relative location relationship and a correspondence between the preset multiple candidate processing orders and the multiple location relationships, the processing order of the multiple code blocks included in the code blocks group, where the multiple location relationships are multiple relative location relationships between a currently processed code blocks group and a code blocks group that is already processed and that is adjacent to the currently processed code blocks group.

That is, both the multiple candidate processing orders of the code blocks and the correspondence between the multiple candidate processing orders and the multiple location relationships may be preset. The encoder side may determine, directly according to the preset correspondence, the processing order corresponding to the code blocks in the currently processed code blocks group when determining the processing order of the code blocks in the currently processed code blocks group, where the multiple candidate processing orders and the correspondence are similar to those in the foregoing embodiment, and details are not described herein again.

Optionally, in an embodiment, writing the first processing order to the bitstream includes arranging indexes of the code blocks group according to the first processing order, encoding the arranged indexes of the code blocks group, and writing the encoded indexes to the bitstream, or arranging coordinates of the code blocks group according to the first processing order, encoding the arranged coordinates of the code blocks group, and writing the encoded coordinates to the bitstream.

After the processing order of the code blocks groups is determined, the processing order may be written to the bitstream by means of indexes or coordinates, or in another manner such that when a decoder side performs decoding, the decoder side can directly acquire an encoding order of the code blocks groups during encoding. Further, there may be the following two manners.

In one manner, index numbers, for example, 0 to N−1, may be allocated to the code blocks groups in the coded image by means of line scan from left to right and from top to bottom. The N index numbers are written to the bitstream according to the optimum processing order obtained by means of calculation.

In the other manner, a horizontal coordinate value and a vertical coordinate value may be allocated to the code blocks group from left to right and from top to bottom. For example, (x, y) indicates a code block. If a coded image has w code blocks groups and h code blocks groups respectively in a horizontal direction and a vertical direction, the coded image has N code blocks groups in total, where N=w*h, and value ranges of x and y are respectively 0≦x≦w−1 and 0≦y≦h−1. The N groups of coordinates may be encoded according to the optimum processing order obtained by means of calculation. For example, the N horizontal coordinate values and the N vertical coordinate values may be independently sequentially encoded using an encoding manner similar to pulse code modulation (PCM). Alternatively, the N horizontal coordinate values and the N vertical coordinate values may be encoded using an encoding manner similar to differential pulse code modulation (DPCM).

After an optimum processing order O of the code blocks groups is encoded using the foregoing method, a result of the encoding is output to a video bitstream such that the decoder side performs decoding according to the optimum processing order.

Optionally, in an embodiment, a coding cost of the code blocks group includes at least one of a quantity of bits consumed to encode the code blocks group, or distortion of the code blocks group. The coding cost of the code blocks group is an important criterion for measuring quality of encoding of the blocks group. A quantity of bits consumed to encode the block and quality of the block after reconstruction are determined when a coding cost is calculated. A smaller value of the coding cost indicates better encoding of the block.

It should be understood that, a first processing order of code blocks groups included in the target image may be determined according to the method in this embodiment of the present disclosure when a target image is to be encoded. A processing order of code blocks in some code blocks groups may be determined when a processing order of code blocks in the code blocks groups is determined, and a processing order of code blocks in other code blocks groups may be determined according to another technical solution or predetermined.

In this embodiment of the present disclosure, a first processing order of multiple code blocks groups included in a target image is determined according to a total coding cost of the target image, and the multiple code blocks groups are encoded according to the first processing order such that a spatial correlation in the target image can be fully utilized, thereby improving compression efficiency during encoding.

FIG. 2 is a flowchart of a decoding method according to an embodiment of the present disclosure, and the method may include the following steps.

Step 201: Acquire a first processing order of multiple code blocks groups of a target image from a bitstream.

Step 202: Determine, according to the first processing order, a processing order of multiple code blocks included in a code blocks group of the multiple code blocks groups.

Step 203: Decode the bitstream according to the first processing order and the processing order of the multiple code blocks included in the code blocks group.

In this embodiment of the present disclosure, a processing order of code blocks included in each code blocks group is determined according to a first processing order that can achieve a minimum total coding cost and that is determined on an encoder side, and a bitstream of a target image is decoded according to the first processing order and the processing order of the code blocks in each code blocks group. In an encoding process, a spatial correlation of the target image is fully utilized, thereby improving compression efficiency during encoding.

Optionally, in an embodiment, before determining, according to the first processing order, a processing order of multiple code blocks included in a code blocks group of the multiple code blocks groups, the method further includes determining multiple candidate processing orders of the code blocks, and determining a correspondence between the multiple candidate processing orders and multiple location relationships, where the multiple location relationships are multiple relative location relationships between a currently processed code blocks group and a code blocks group that is already processed and that is adjacent to the currently processed code blocks group.

To ensure matching between encoding and decoding, a decoder side uses a solution that is the same as a solution used by the encoder side to determine, according to the processing order of the code blocks group, a processing order of code blocks in a current code blocks group. The code blocks in the current code blocks group may have multiple preset candidate processing orders, where each candidate processing order corresponds to one location relationship, and the location relationship is a relative location relationship between a currently processed code blocks group and a code blocks group that is already processed and that is adjacent to the currently processed code blocks group. A relative location relationship between the current code blocks group and a code blocks group that is already decoded and that is adjacent or close to the current code blocks group may be first determined, and then a processing order of code blocks in a corresponding code blocks group is determined in a preconfigured correspondence according to the determined relative location relationship when the current code blocks group is to be decoded. After the processing order of the code blocks is determined, all code blocks in the current code blocks group are decoded according to the processing order, and after the decoding is finished, a next code blocks group is processed according to the first processing order. Similar to the current code blocks group, a processing order of code blocks in the next code blocks group needs to be determined according to a relative location relationship, and so on, until all code blocks groups of the target image are completely decoded according to the first processing order.

Optionally, in an embodiment, determining, according to the first processing order, a processing order of code blocks in each code blocks group of the multiple code blocks groups includes determining, according to the first processing order, a relative location relationship between the code blocks group and a code blocks group that is already processed and that is adjacent to the code blocks group, and determining, according to the correspondence and the relative location relationship, the processing order of the multiple code blocks included in the code blocks group. Optionally, in an embodiment, determining multiple candidate processing orders of the code blocks includes using preset multiple candidate processing orders of the code blocks. The preset multiple candidate processing orders of the code blocks may be determined using multiple methods. For example, the preset multiple candidate processing orders of the code blocks are determined according to a division manner of the code blocks included in the code blocks group. The division manner of the code blocks may include equal-size division, that is, sizes of the code blocks in the code blocks group are equal, which is used, for example, in the H.264/AVC. The division manner of the code blocks may further include non-equal-size division, for example, in the HEVC. In a case of equal-size division, the preset multiple candidate processing orders of the code blocks may be shown in FIG. 4. In a case of non-equal-size division, the preset multiple candidate processing orders of the code blocks may be shown in FIG. 3. It should be understood that the several processing orders shown in FIG. 3 and FIG. 4 are only some examples, and a preset processing order of code blocks is not limited thereto, and may be any order.

For example, the decoder side may preset multiple processing orders of the code blocks in the code blocks group, and a relative locations correspondence between the code blocks group and a decoded code blocks group. For example, four processing orders of code blocks shown in FIG. 4 are preset, where an order 0 is progressive scanning from left to right, an order 2 is progressive scanning from right to left, an order 3 is column-by-column scanning from top to bottom, and an order 1 is column-by-column scanning from bottom to top. The relative locations of the code blocks group and the code blocks group that is already decoded may be 16 relative locations shown in FIG. 5:

1. There is no code blocks group that is already decoded and that is adjacent to the code blocks group.

2. A code blocks group above the code blocks group has been decoded.

3. A code blocks group on the right of the code blocks group has been decoded.

4. A code blocks group below the code blocks group has been decoded.

5. A code blocks group on the left of the code blocks group has been decoded.

6. Code blocks groups above and on the right of the code blocks group have been decoded.

7. Code blocks groups below and on the right of the code blocks group have been decoded.

8. Code blocks groups on the left of and below the code blocks group have been decoded.

9. Code blocks groups on the left of and above the code blocks group have been decoded.

10. Code blocks groups above and below the code blocks group have been decoded.

11. Code blocks groups on the left and on the right of the code blocks group have been decoded.

12. Code blocks groups above, below, and on the left of the code blocks group have been decoded.

13. Code blocks groups on the left of, on the right of, and above the code blocks group have been decoded.

14. Code blocks groups above, below, and on the right of the code blocks group have been decoded.

15. Code blocks groups on the left of, on the right of, and below the code blocks group have been decoded.

16. Code blocks groups above, below, on the left of, and on the right of the code blocks group have been decoded.

The decoder side may further preconfigure a correspondence between the foregoing four processing orders and the foregoing 16 relative location relationships. For example, a relative location relationship 1 corresponds to the order 0, a relative location relationship 2 corresponds to the order 3, and a relative location relationship 3 corresponds to the order 2.

It can be learned from the foregoing correspondence that, a corresponding case is selected from the foregoing 16 cases for the current code blocks group when a different code blocks group processing order is given. A processing order of code blocks in the current code blocks group is subsequently determined, and then a decoding operation is performed on the code blocks in the current code blocks group according to the given code block processing order.

It should be understood that, the foregoing multiple preset modes and correspondences of the decoder side are the same as preset modes and correspondences of the encoder side.

Optionally, in an embodiment, determining, according to the first processing order, a processing order of multiple code blocks included in the code blocks group includes determining, according to the first processing order, a relative location relationship between the code blocks group and a code blocks group that is already processed and that is adjacent to the code blocks group, and determining, according to the relative location relationship and a correspondence between the preset multiple candidate processing orders and the multiple location relationships, the processing order of the multiple code blocks included in the code blocks group, where the multiple location relationships are multiple relative location relationships between a currently processed code blocks group and a code blocks group that is already processed and that is adjacent to the currently processed code blocks group.

That is, both the multiple candidate processing orders of the code blocks and the correspondence between the multiple candidate processing orders and the multiple location relationships may be preset. The encoder side may determine, directly according to the preset correspondence, the processing order corresponding to the code blocks in the currently processed code blocks group when determining the processing order of the code blocks in the currently processed code blocks group, where the multiple candidate processing orders and the correspondence are similar to those in the foregoing embodiment, and details are not described herein again.

Optionally, in an embodiment, step 201 may include decoding the bitstream to obtain arranged indexes of the multiple code blocks groups, and determining the first processing order according to an arrangement order of the indexes of the multiple code blocks groups, or decoding the bitstream to obtain arranged coordinates of the multiple code blocks groups, and determining the first processing order according to an arrangement order of the coordinates of the multiple code blocks groups.

After determining the processing order of the code blocks groups, the encoder side may write the processing order to the bitstream by means of indexes or coordinates, or in another manner such that when the decoder side performs decoding, the decoder side can directly acquire an encoding order of the code blocks groups during encoding. Further, there may be the following two manners.

In one manner, index numbers, for example, 0 to N−1, may be allocated to the code blocks groups in the coded image by means of line scan from left to right and from top to bottom. The N index numbers are written to the bitstream according to the optimum processing order obtained by means of calculation.

In the other manner, a horizontal coordinate value and a vertical coordinate value may be allocated to the code blocks group from left to right and from top to bottom. For example, (x,y) indicates a code block. If a coded image has w code blocks groups and h code blocks groups respectively in a horizontal direction and a vertical direction, the coded image has N code blocks groups in total, where N=w*h, and value ranges of x and y are respectively 0≦x≦w−1 and 0≦y≦h−1. The N groups of coordinates may be encoded according to the optimum processing order obtained by means of calculation. For example, the N horizontal coordinate values and the N vertical coordinate values may be independently sequentially encoded using an encoding manner similar to PCM. Alternatively, the N horizontal coordinate values and the N vertical coordinate values may be encoded using an encoding manner similar to DPCM.

That is, correspondingly, the decoder side may learn the processing order of the code blocks groups in the foregoing two manners according to information that is written by the encoder side to the bitstream.

In this embodiment of the present disclosure, a processing order of code blocks included in each code blocks group is determined according to a first processing order that can achieve a minimum total coding cost and that is determined on an encoder side, and a bitstream of a target image is decoded according to a first processing order and the processing order of the code blocks in each code blocks group. In an encoding process, a spatial correlation of the target image is fully utilized, thereby improving compression efficiency during encoding.

FIG. 3 is a schematic diagram of a processing order of code blocks according to an embodiment of the present disclosure. FIG. 4 is a schematic diagram of a processing order of code blocks according to another embodiment of the present disclosure.

It should be understood that, the processing order of the code blocks groups in the embodiments of the present disclosure may be any order. Determining or selection of the processing order of the code blocks groups is described in detail in the foregoing embodiment in FIG. 2, and details are not described herein again.

A processing order of all code blocks in a code blocks group may be selected from preset multiple candidate processing orders. For example, four processing orders of Z-shaped scanning shown in FIG. 3 may be preset, or four processing orders of progressive scanning shown in FIG. 4 may be preset. Herein, FIG. 3 and FIG. 4 are used only for ease of description by examples. In practice, any quantity of processing orders may be preset, and a processing order may be arbitrary or skipped, which is not limited in the present disclosure.

If code blocks in a code blocks group have different sizes, which is similar to a case in which, for example, CUs in a CTU in the HEVC may have different sizes, an order of line scan is not proper to be used to process the code blocks. In this case, the four processing orders shown in FIG. 3 may be selected as preset processing orders of the code blocks. If the code blocks in the code blocks group have a same size, which is similar to a case in which, for example, SMBs in an MB in the H.264/AVC have a same size, the four processing orders of progressive scanning shown in FIG. 4 may be selected as preset processing orders of the code blocks. A number on a code block represents a processing order of the corresponding code block.

FIG. 5 is a schematic diagram of a correspondence between candidate processing orders of code blocks and multiple location relationships according to an embodiment of the present disclosure.

An encoder side may preset a correspondence between multiple processing orders of code blocks in a code blocks group, and relative locations of the code blocks group and a code blocks group that is already encoded. For example, four processing orders of code blocks may be preset, where an order 0 is progressive scanning from left to right, an order 1 is progressive scanning from right to left, an order 2 is column-by-column scanning from top to bottom, and an order 3 is column-by-column scanning from bottom to top. The relative locations of the code blocks group and the code blocks group that is already encoded may be preset to 16 relative locations shown in FIG. 5:

1. There is no code blocks group that is already encoded and that is adjacent to the code blocks group.

2. A code blocks group above the code blocks group has been encoded.

3. A code blocks group on the right of the code blocks group has been encoded.

4. A code blocks group below the code blocks group has been encoded.

5. A code blocks group on the left of the code blocks group has been encoded.

6. Code blocks groups above and on the right of the code blocks group have been encoded.

7. Code blocks groups below and on the right of the code blocks group have been encoded.

8. Code blocks groups on the left of and below the code blocks group have been encoded.

9. Code blocks groups on the left of and above the code blocks group have been encoded.

10. Code blocks groups above and below the code blocks group have been encoded.

11. Code blocks groups on the left and on the right of the code blocks group have been encoded.

12. Code blocks groups above, below, and on the left of the code blocks group have been encoded.

13. Code blocks groups on the left of, on the right of, and above the code blocks group have been encoded.

14. Code blocks groups above, below, and on the right of the code blocks group have been encoded.

15. Code blocks groups on the left of, on the right of, and below the code blocks group have been encoded.

16. Code blocks groups above, below, on the left of, and on the right of the code blocks group have been encoded.

The encoder side may further preconfigure a correspondence between the foregoing four processing orders and the foregoing 16 relative location relationships. For example, a relative location relationship 1 corresponds to the order 0, a relative location relationship 2 corresponds to the order 3, and a relative location relationship 3 corresponds to the order 2.

It should be understood that, the correspondence shown in FIG. 5 is used only for ease of description by examples. In practice, any quantity of processing orders and any quantity of relative location relationships may be preset, and a processing order may be arbitrary or skipped, which is not limited in the present disclosure.

It can be learned from the foregoing correspondence that, when a different code blocks group processing order is given, a corresponding case is selected from the foregoing 16 cases for the current code blocks group. A processing order of code blocks in the current code blocks group is subsequently determined, then an encoding operation is performed on the code blocks in the current code blocks group according to the given code block processing order, and a coding cost is calculated. For example, when the current code blocks group is to be processed according to the first processing order, it can be first determined that code blocks groups on the left and right of the current code blocks group have been encoded. It may be determined according to the relative location relationships in FIG. 5 that a current code block is in a location relationship 11, and a code block processing order corresponding to the current code block is an order 0. Subsequently, the encoder side may perform progressive scanning from left to right on the code blocks in the code blocks group according to the order 0, to encode the code blocks. After all the code blocks are completely encoded, a next code blocks group is processed according to a first encoding order.

Herein, for the determining of the code block processing order, a pixel value in the current code blocks group is predicted using as much as possible a pixel value in an adjacent code blocks group that is already processed. A spatial correlation of a coded image is relatively fully considered, which helps improve compression efficiency.

FIG. 6 is a flowchart of encoding on an encoder side according to an embodiment of the present disclosure.

First, a target image 601 is divided into multiple non-overlapping code blocks groups. A division method for a code blocks group may depend on an encoding and decoding standard. For example, a code blocks group obtained by means of division in the HEVC may be a CTU, and a code blocks group obtained by means of division in the H.264/AVC may be an MB. In addition, division of the code blocks group may also be preset or arbitrary. Further, the code blocks group may further continue to be divided into multiple code blocks for which coding parameters can be independently determined. The foregoing code blocks group or code block is a set of pixels. For example, it indicates that the block is a two-dimensional pixel array if a size of the code block is N×N, which has N-pixels in both a horizontal direction and a vertical direction.

The encoder side performs a prediction operation on the code block, to acquire a predictor 602 of a pixel in the code block. The prediction operation may be generally classified into inter-frame prediction 611 and intra-frame prediction 612. Further, a difference between an original value 603 of the pixel of the code block and a predictor 602 of the pixel of the code block is calculated. A set of predicted differences of pixels in the code block is referred to as a residual 604 of the code block. After transformation and quantization 613 are performed on the residual 604, a transformation quantized coefficient 605 is obtained. Finally, an entropy encoding 614 operation is performed on the transformation quantized coefficient 605, and a bit string output in entropy encoding is written to a bitstream. In addition, dequantization and inverse transformation 615 operations are performed on the transformation quantized coefficient 605 on which transformation and quantization 613 have been performed, to obtain a reconstruction residual 606, and the reconstruction residual 606 and the predictor 602 of the current code block are added together to obtain reconstruction 607 of the block. Reconstruction 607 of the current block is to be used for predicting a subsequent code block, where the subsequent code block may be a to-be-processed code block in a current coded image, or may be a code block in a subsequent to-be-encoded image.

Before performing predictive coding on the target image 601, the encoder side may first determine a processing order of multiple code blocks groups included in the target image 601. Further, a coding cost of each code blocks group varies with the processing order when the code blocks groups are processed in different processing orders. Therefore, it may be determined that a processing order that can achieve a minimum total coding cost of all code blocks groups may be used as a processing order of the code blocks groups when encoding is actually performed. For a specific determining method, reference may be made to related steps and the formulas (1) and (2), and the like in the foregoing embodiment in FIG. 1, and details are not described herein again.

A processing order of code blocks in each code blocks group may be determined after the processing order of the code blocks groups is determined. Further, a processing order between a current code blocks group and a code blocks group adjacent to the current code blocks group may be determined according to the processing order of the code blocks groups such that a processing order of code blocks in the current code blocks group is determined. The code blocks in the current code blocks group may have multiple preset candidate processing orders, where each candidate processing order corresponds to one location relationship, and the location relationship is a relative location relationship between a currently processed code blocks group and a code blocks group that is already processed and that is adjacent to the currently processed code blocks group. A relative location relationship between the current code blocks group and a code blocks group that is already encoded and that is adjacent or close to the current code blocks group may be first determined, and then a processing order of code blocks in a corresponding code blocks group is determined in a preconfigured correspondence according to the determined relative location relationship when the current code blocks group is to be encoded. After the processing order of the code blocks is determined, all code blocks in the current code blocks group are encoded according to the processing order, and after the encoding is finished, a next code blocks group is processed according to the processing order of the code blocks groups. Similar to the current code blocks group, a processing order of code blocks in the next code blocks group needs to be determined according to a relative location relationship, and so on, until all code blocks groups of the target image are completely encoded according to the processing order. The foregoing “processing” may include the prediction operations 611 and 612, the operation of determining the residual 604, the transformation/quantization 613 operation, the entropy encoding 614 operation, the dequantizaiton/inverse transformation 615 operation, the reconstruction 607 operation, and the like.

In addition, the processing order of the code blocks groups may be written to the bitstream such that a decoder side performs decoding according to the order when a bitstream is generated. For an identification method for a specific processing order, reference may be made to a corresponding method in FIG. 1, and details are not described herein again.

In this embodiment of the present disclosure, a processing order of multiple code blocks groups included in a target image is determined according to a total coding cost of the target image, and the multiple code blocks groups are encoded according to the processing order such that a spatial correlation in the target image can be fully utilized, thereby improving compression efficiency during encoding.

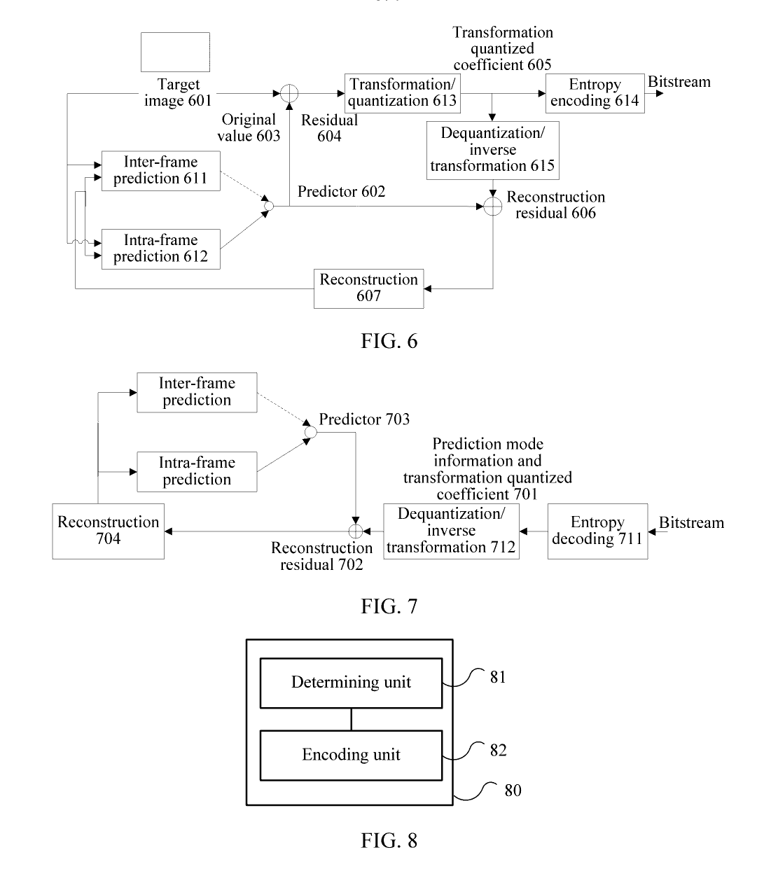

FIG. 7 is a flowchart of decoding on a decoder side according to an embodiment of the present disclosure.

A processing method of the decoder side corresponds to that of an encoder side. After obtaining a bitstream encoded and output by the encoder side, the decoder side may acquire, from the bitstream, a processing order when the encoder side encodes a code blocks group. According to the processing order, the decoder side can determine a relative location relationship between a currently processed code blocks group and a code blocks group that is already decoded and that is adjacent or close to the currently processed code blocks group, and then a processing order of code blocks in a corresponding code blocks group is determined in a preconfigured correspondence according to the determined relative location relationship. After the processing order of the code blocks is determined, all code blocks in the current code blocks group are decoded according to the processing order, and after the decoding is finished, a next code blocks group is processed according to the first processing order. Similar to the current code blocks group, a processing order of code blocks in the next code blocks group needs to be determined according to a relative location relationship, and so on, until all code blocks groups of the target image are completely decoded according to the first processing order. Further, reference may be made to the foregoing method in FIG. 2, and details are not described herein again. It should be understood that, the foregoing “processing” by the decoder side includes performing entropy decoding 711 on an input bitstream to obtain prediction mode information and a transformation quantized coefficient 701. A decoder uses the prediction mode information 701 and a block or image that is already reconstructed to obtain predictor 703 of a current code block, dequantization/inverse transformation 712 is performed on the transformation quantized coefficient 701 to obtain a reconstruction residual 702, and the reconstruction residual 702 and the predictor 703 of the current code block are added together to obtain reconstruction 704 of the code block. The encoder side writes information about each code block to the bitstream according to a determined processing order of code blocks groups and a processing order of code blocks in the code blocks group. Correspondingly, the decoder side sequentially put reconstructed blocks, which are obtained by means of decoding, of the code blocks into a reconstructed image in the foregoing order.

In this embodiment of the present disclosure, a processing order of multiple code blocks groups included in a target image is determined according to a total coding cost of the target image, and the multiple code blocks groups are encoded according to the processing order such that a spatial correlation in the target image can be fully utilized, thereby improving compression efficiency during encoding.

FIG. 8 is a schematic block diagram of an encoder 80 according to an embodiment of the present disclosure. The encoder 80 in FIG. 8 includes a determining unit 81 and an encoding unit 82.

The determining unit 81 determines, according to a total coding cost of a target image, a first processing order of multiple code blocks groups included in the target image. The encoding unit 82 encodes a code blocks group of the multiple code blocks groups according to the first processing order determined by the determining unit 81, to generate a bitstream, and the encoding unit 82 writes the first processing order determined by the determining unit 81 to the bitstream.

The encoder 80 in this embodiment of the present disclosure determines, according to a total coding cost of a target image, a first processing order of multiple code blocks groups included in the target image, and encodes the multiple code blocks groups according to the first processing order such that a spatial correlation in the target image can be fully utilized, thereby improving compression efficiency during encoding.

It should be understood that, the target image in this embodiment of the present disclosure is a to-be-encoded image, or may be referred to as a coded image. The target image is divided into multiple non-overlapping code blocks groups, where the code blocks group may be equivalent to a CTU in the HEVC, or may be equivalent to a MB in the H.264/AVC, or the like. The code blocks group may continue to be divided into multiple code blocks for which coding parameters can be independently determined, where the code block may be equivalent to a CU in the HEVC, or may be equivalent to a SMB in the H.264/AVC, or the like.

Optionally, in an embodiment, the determining unit 81 is further configured to determine a total coding cost corresponding to each processing order of all processing orders of the multiple code blocks groups, where the total coding cost corresponding to each processing order is a sum of coding costs when the multiple code blocks groups are encoded according to each processing order, and determine that a processing order corresponding to a minimum total coding cost of the total coding costs corresponding to all the processing orders is the first processing order.

Further, when code blocks groups are processed in different processing orders, a coding cost of each code blocks group varies with the processing order. The coding cost of the code blocks group is an important criterion for measuring quality of encoding of the blocks group. A quantity of bits consumed to encode the block and quality of the block after reconstruction when a coding cost is calculated. A smaller value of the coding cost indicates better encoding of the block. Therefore, a processing order that can achieve a minimum total coding cost of all code blocks groups may be used as an optimum processing order. Therefore, a question of determining an optimum processing order may be converted into a question of solving a minimum total coding cost:

$$J ( {O}_{{S}_{N}} ) = min DP ( {S}_{N} , {O}_{{S}_{N}} ) = min {\sum }_{j = 1 , i ∈ \{ 1 \leq i \leq N , i ∉ {S}_{j , k} \}}^{N} RD ( {S}_{j , k} , i ) , \qquad ( 4 )$$

where N indicates a total quantity of code blocks groups, 1≦i≦N represents that indexes of the code blocks groups are indicated in a left-to-right top-to-bottom order, O is a vector indicating a processing order of the code blocks groups, each item of O is an arrangement manner of indexes of the code blocks groups, total possible processing orders are a permutation N! of N, a processing order indicated when O=[1,2, . . . , N] is a traditional line scan processing order, S_{j,k} is a set, including indexes of j blocks groups that are already processed, k indicates that the j blocks groups that are already processed are the k^{th} combination of C_{N}^{j} possible combinations of j blocks groups selected from the N blocks groups, i indicates one of blocks groups that are not encoded, RD(S_{j,k},i) indicates a cost required for processing a code blocks group i in a case in which all code blocks groups in S_{j,k} have been processed, S_{N} indicates a set of all N code blocks groups, O_{S}_{_{N}} indicates an optimum processing order of the N code blocks groups, and an objective of the optimum question is to find a processing order O_{S}_{_{N}} such that a total cost DP(S_{N}, O_{S}_{_{N}}) of all the N code blocks groups is the minimum.

To solve J(O_{S}_{_{N}}), a cost RD(S_{j,k},i) of each code blocks group needs to be calculated. After a cost RD(S_{j,k},i) of one code blocks group is obtained, a method described in a formula (5) may be used to determine an optimum processing order of the code blocks groups.

$$DP ( {S}_{j + 1 , k} , {O}_{{S}_{j , k}} ) = {min}_{i ∈ \{ 1 \leq i \leq N , i ∉ {S}_{j , k} \}} \{ DP ( {S}_{j , k} , {O}_{{S}_{j , k}} ) + RD ( {S}_{j , k} , i ) \} , \qquad ( 5 )$$

where j,1≦j≦N−1 indicates a quantity of code blocks groups that are already processed, k,1≦k≦C_{N}^{k} indicates the k^{th} combination of all possible combinations of the j blocks groups that are already processed, S_{j,k} is a set, including indexes of the j blocking groups that are already processed in the foregoing case of the k^{th} combination, a cost function DP(S_{j,k}, O_{S}_{_{j,k}}) indicates a sum of costs of all blocking groups in a code blocks group set S_{j,k}, that is, a total cost required to process, using the optimum processing order O_{S}_{_{j,k}}, the j code blocks groups included in S_{j,k}, and RD(S_{j,k},i) indicates a cost caused when the blocking group i is encoded in a case in which all the j blocks groups indicated by the k^{th} combination indicated by S_{j,k} have been processed.

An example is provided for describing the foregoing process, where there are three code blocks groups numbered 1, 2, and 3 to be processed. There are three possible cases for S_{j,k}, that is, S_{j,k}={1,2}, S_{j,k}={1,3}, and S_{j,k}={2,3} when j=2, optimum encoding orders thereof are O_{{1,2}}=1,2, O_{{1,3}}=3,1, and O_{{2,3}}=3,2, and optimum costs corresponding thereto are DP({1,2}, O_{{1,2}}), DP({1,3}, O_{{1,3}}), and DP({2,3}, O_{{2,3}}) DP({2,3}, O_{{2,3}}). Further, a case in which j=3 is considered. In the three possible cases for S_{j,k}, other code blocks groups are respectively a blocking group numbered 3, a blocking group numbered 2, and a blocking group numbered 1, and corresponding costs for encoding the blocking groups are respectively RD({1,2},3), RD({1,3},2), and RD({2,3},1). In this case, a minimum cost DP({1,2,3}, O_{{1,2,3}}) of the three code blocks groups with encoding numbers 1, 2, and 3 may be obtained by means of calculation using a formula (6), and subsequently, an optimum processing order O_{{1,2,3}} is determined.

$$DP ( \{ 1 , 2 , 3 \} , {O}_{\{ 1 , 2 , 3 \}} ) = min \{ \begin{matrix}DP ( \{ 2 , 3 \} , {O}_{\{ 2 , 3 \}} ) + RD ( \{ 2 , 3 \} , 1 ) , \\ DP ( \{ 1 , 2 \} , {O}_{\{ 1 , 2 \}} ) + RD ( \{ 1 , 2 \} , 3 ) , \\ DP ( \{ 1 , 3 \} , {O}_{\{ 1 , 3 \}} ) + RD ( \{ 1 , 3 \} , 2 ) .\end{matrix} \} . \qquad ( 6 )$$

Optionally, in an embodiment, the encoding unit is further configured to determine, according to the first processing order using the determining unit, a processing order of multiple code blocks included in the code blocks group, and encode the code blocks group according to the first processing order and the processing order of the multiple code blocks included in the code blocks group.

After the processing order of the code blocks groups is determined, the processing order of the code blocks included in the code blocks group may further need to be determined. A processing order of code blocks in a current code blocks group may be determined according to the processing order of the code blocks groups. That is, a processing order between the current code blocks group and a code blocks group adjacent to the current code blocks group may be determined according to the processing order of the code blocks groups such that the processing order of the code blocks in the current code blocks group is determined. The code blocks in the current code blocks group may have multiple preset candidate processing orders, where each candidate processing order corresponds to one location relationship, and the location relationship is a relative location relationship between a currently processed code blocks group and a code blocks group that is already processed and that is adjacent to the currently processed code blocks group. When the current code blocks group is to be encoded, a relative location relationship between the current code blocks group and a code blocks group that is already encoded and that is adjacent or close to the current code blocks group may be first determined, and then a processing order of code blocks in a corresponding code blocks group is determined in a preconfigured correspondence according to the determined relative location relationship. After the processing order of the code blocks is determined, all code blocks in the current code blocks group are encoded according to the processing order, and after the encoding is finished, a next code blocks group is processed according to the first processing order. Similar to the current code blocks group, a processing order of code blocks in the next code blocks group needs to be determined according to a relative location relationship, and so on, until all code blocks groups of the target image are completely encoded according to the first processing order.

Optionally, in an embodiment, the determining unit 81 is further configured to determine multiple candidate processing orders of the code blocks, and determine a correspondence between the multiple candidate processing orders and multiple location relationships, where the multiple location relationships are multiple relative location relationships between a currently processed code blocks group and a code blocks group that is already processed and that is adjacent to the currently processed code blocks group. Optionally, in an embodiment, the determining unit 81 is further configured to use preset multiple candidate processing orders of the code blocks. The preset multiple candidate processing orders of the code blocks may be determined using multiple methods. For example, the preset multiple candidate processing orders of the code blocks are determined according to a division manner of the code blocks included in the code blocks group. The division manner of the code blocks may include equal-size division, that is, sizes of the code blocks in the code blocks group are equal, for example, in the H.264/AV. The division manner of the code blocks may further include non-equal-size division, for example, in the HEVC. In a case of equal-size division, the preset multiple candidate processing orders of the code blocks may be shown in FIG. 4. In a case of non-equal-size division, the preset multiple candidate processing orders of the code blocks may be shown in FIG. 3. It should be understood that the several processing orders shown in FIG. 3 and FIG. 4 are only some examples, and a preset processing order of code blocks is not limited thereto, and may be any order.

For example, the encoder 80 may preset a correspondence between multiple processing orders of the code blocks in the code blocks group, and relative locations of the code blocks group and an already encoded code blocks group. For example, four processing orders of code blocks shown in FIG. 4 may be preset, where an order 0 is progressive scanning from left to right, an order 2 is progressive scanning from right to left, an order 3 is column-by-column scanning from top to bottom, and an order 1 is column-by-column scanning from bottom to top. The relative locations of the code blocks group and the code blocks group that is already encoded may be 16 relative locations shown in FIG. 5:

1. There is no code blocks group that is already encoded and that is adjacent to the code blocks group.

2. A code blocks group above the code blocks group has been encoded.

3. A code blocks group on the right of the code blocks group has been encoded.

4. A code blocks group below the code blocks group has been encoded.

5. A code blocks group on the left of the code blocks group has been encoded.

6. Code blocks groups above and on the right of the code blocks group have been encoded.

7. Code blocks groups below and on the right of the code blocks group have been encoded.

8. Code blocks groups on the left of and below the code blocks group have been encoded.

9. Code blocks groups on the left of and above the code blocks group have been encoded.

10. Code blocks groups above and below the code blocks group have been encoded.

11. Code blocks groups on the left and on the right of the code blocks group have been encoded.

12. Code blocks groups above, below, and on the left of the code blocks group have been encoded.

13. Code blocks groups on the left of, on the right of, and above the code blocks group have been encoded.

14. Code blocks groups above, below, and on the right of the code blocks group have been encoded.

15. Code blocks groups on the left of, on the right of, and below the code blocks group have been encoded.

16. Code blocks groups above, below, on the left of, and on the right of the code blocks group have been encoded.

The encoder 80 may further preconfigure a correspondence between the foregoing four processing orders and the foregoing 16 relative location relationships. For example, a relative location relationship 1 corresponds to the order 0, a relative location relationship 2 corresponds to the order 3, and a relative location relationship 3 corresponds to the order 2.

It can be learned from the foregoing correspondence that, a corresponding case is selected from the foregoing 16 cases for the current code blocks group when a different code blocks group processing order is given. A processing order of code blocks in the current code blocks group is subsequently determined, then an encoding operation is performed on the code blocks in the current code blocks group according to the given code block processing order, and a coding cost is calculated.

Herein, for the determining of the code block processing order, a pixel value in the current code blocks group is predicted using as much as possible a pixel value in an adjacent code blocks group that is already processed. A spatial correlation of a coded image is relatively fully considered, which helps improve compression efficiency.

Optionally, in an embodiment, the determining unit 81 is further configured to determine, according to the first processing order, a relative location relationship between the code blocks group and a code blocks group that is already processed and that is adjacent to the code blocks group, and determine, according to the correspondence and the relative location relationship, the processing order of the multiple code blocks included in the code blocks group.

Optionally, in an embodiment, the determining unit 81 is further configured to determine, according to the first processing order, a relative location relationship between the code blocks group and a code blocks group that is already processed and that is adjacent to the code blocks group, and determine, according to the relative location relationship and a correspondence between the preset multiple candidate processing orders and the multiple location relationships, the processing order of the multiple code blocks included in the code blocks group, where the multiple location relationships are multiple relative location relationships between a currently processed code blocks group and a code blocks group that is already processed and that is adjacent to the currently processed code blocks group.

That is, both the multiple candidate processing orders of the code blocks and the correspondence between the multiple candidate processing orders and the multiple location relationships may be preset. The encoder 80 may determine, directly according to the preset correspondence, the processing order corresponding to the code blocks in the currently processed code blocks group when determining the processing order of the code blocks in the currently processed code blocks group, where the multiple candidate processing orders and the correspondence are similar to those in the foregoing embodiment, and details are not described herein again.

Optionally, in an embodiment, the encoding unit 82 is further configured to arrange indexes of the code blocks group according to the first processing order, and encode the arranged indexes of the code blocks group and write the encoded indexes to the bitstream, or arrange coordinates of the code blocks group according to the first processing order, and encode the arranged coordinates of the code blocks group and write the encoded coordinates to the bitstream.

After the processing order of the code blocks groups is determined, the processing order may be written to the bitstream by means of indexes or coordinates, or in another manner such that when a decoder side performs decoding, the decoder side can directly acquire an encoding order of the code blocks groups during encoding. Further, there may be the following two manners.

In one manner, index numbers, for example, 0 to N−1, may be allocated to the code blocks groups in the coded image by means of line scan from left to right and from top to bottom. The N index numbers are written to the bitstream according to the optimum processing order obtained by means of calculation.

In the other manner, a horizontal coordinate value and a vertical coordinate value may be allocated to the code blocks group from left to right and from top to bottom. For example, (x, y) indicates a code block. If a coded image has w code blocks groups and h code blocks groups respectively in a horizontal direction and a vertical direction, the coded image has N code blocks groups in total, where N=w*h, and value ranges of x and y are respectively 0≦x≦w−1 and 0≦y≦h−1. The N groups of coordinates may be encoded according to the optimum processing order obtained by means of calculation. For example, the N horizontal coordinate values and the N vertical coordinate values may be independently sequentially encoded using an encoding manner similar to PCM. Alternatively, the N horizontal coordinate values and the N vertical coordinate values may be encoded using an encoding manner similar to DPCM.

After an optimum processing order 0 of the code blocks groups is encoded using the foregoing method, a result of the encoding is output to a video bitstream such that the decoder side performs decoding according to the optimum processing order.

Optionally, in an embodiment, a coding cost of the code blocks group includes at least one of the following a quantity of bits consumed by the encoding unit to encode the code blocks group, or distortion of the code blocks group.

The coding cost of the code blocks group is an important criterion for measuring quality of encoding of the blocks group. A quantity of bits consumed to encode the block and quality of the block after reconstruction are determined when a coding cost is calculated. A smaller value of the coding cost indicates better encoding of the block.

It should be understood that, when a target image is to be encoded, a first processing order of code blocks groups included in the target image may be determined according to the method in this embodiment of the present disclosure. A processing order of code blocks in some code blocks groups may be determined, and a processing order of code blocks in other code blocks groups may be determined according to another technical solution or predetermined when a processing order of code blocks in the code blocks groups is determined.

The encoder 80 in this embodiment of the present disclosure determines, according to a total coding cost of a target image, a first processing order of multiple code blocks groups included in the target image, and encode the multiple code blocks groups according to the first processing order such that a spatial correlation in the target image can be fully utilized, thereby improving compression efficiency during encoding.

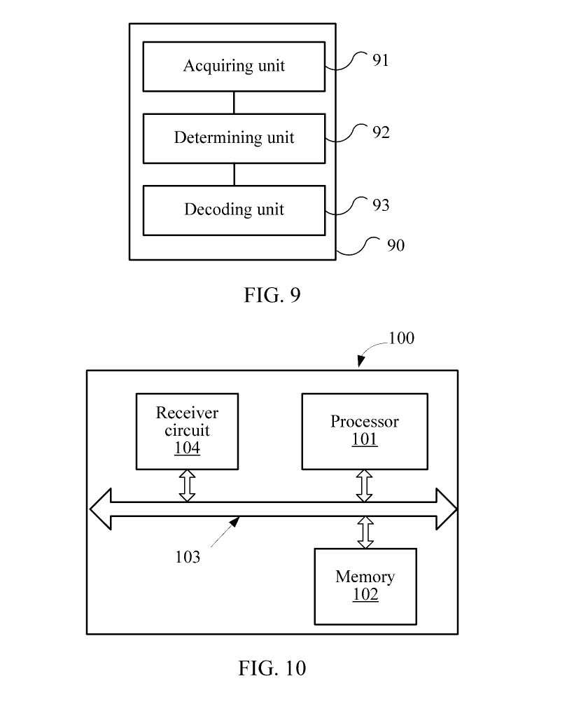

FIG. 9 is a schematic block diagram of a decoder according to an embodiment of the present disclosure. The decoder 90 in FIG. 9 includes an acquiring unit 91, a determining unit 92, and a decoding unit 93.

The acquiring unit 91 acquires a first processing order of multiple code blocks groups of a target image from a bitstream. The determining unit 92 determines, according to the first processing order, a processing order of multiple code blocks included in a code blocks group of the multiple code blocks groups. The decoding unit 93 decodes the bitstream according to the first processing order and the processing order of the multiple code blocks included in the code blocks group.

In this embodiment of the present disclosure, a processing order of code blocks included in each code blocks group is determined according to a first processing order that can achieve a minimum total coding cost and that is determined on an encoder side, and the decoder 90 decodes a bitstream of a target image according to the first processing order and the processing order of the code blocks in each code blocks group. In an encoding process, a spatial correlation of the target image is fully utilized, thereby improving compression efficiency during encoding.

Optionally, in an embodiment, the determining unit 92 is further configured to determine multiple candidate processing orders of the code blocks, and determine a correspondence between the multiple candidate processing orders and multiple location relationships, where the multiple location relationships are multiple relative location relationships between a currently processed code blocks group and a code blocks group that is already processed and that is adjacent to the currently processed code blocks group.

To ensure matching between encoding and decoding, the decoder 90 uses a solution that is the same as a solution used by the encoder side to determine, according to the processing order of the code blocks groups, a processing order of code blocks in a current code blocks group. The code blocks in the current code blocks group may have multiple preset candidate processing orders, where each candidate processing order corresponds to one location relationship, and the location relationship is a relative location relationship between a currently processed code blocks group and a code blocks group that is already processed and that is adjacent to the currently processed code blocks group. A relative location relationship between the current code blocks group and a code blocks group that is already decoded and that is adjacent or close to the current code blocks group may be first determined, and then a processing order of code blocks in a corresponding code blocks group is determined in a preconfigured correspondence according to the determined relative location relationship when the current code blocks group is to be decoded. After the processing order of the code blocks is determined, all code blocks in the current code blocks group are decoded according to the processing order, and after the decoding is finished, a next code blocks group is processed according to the first processing order. Similar to the current code blocks group, a processing order of code blocks in the next code blocks group needs to be determined according to a relative location relationship, and so on, until all code blocks groups of the target image are completely decoded according to the first processing order.

Optionally, in an embodiment, the determining unit 92 is further configured to determine, according to the first processing order, a relative location relationship between the code blocks group and a code blocks group that is already processed and that is adjacent to the code blocks group, and determine, according to the correspondence and the relative location relationship, the processing order of the multiple code blocks included in the code blocks group. Optionally, in an embodiment, the determining unit 92 is further configured to use preset multiple candidate processing orders of the code blocks. The preset multiple candidate processing orders of the code blocks may be determined using multiple methods. For example, the preset multiple candidate processing orders of the code blocks are determined according to a division manner of the code blocks included in the code blocks group. The division manner of the code blocks may include equal-size division, that is, sizes of the code blocks in the code blocks group are equal, which is used, for example, in the H.264/AVC. The division manner of the code blocks may further include non-equal-size division, for example, in the HEVC. In a case of equal-size division, the preset multiple candidate processing orders of the code blocks may be shown in FIG. 4. In a case of non-equal-size division, the preset multiple candidate processing orders of the code blocks may be shown in FIG. 3. It should be understood that the several processing orders shown in FIG. 3 and FIG. 4 are only some examples, and a preset processing order of code blocks is not limited thereto, and may be any order.

For example, a decoder 90 may preset a correspondence between multiple processing orders of the code blocks in the code blocks group, and relative locations of the code blocks group and a code blocks group that is already decoded. For example, four processing orders of code blocks shown in FIG. 4 are preset, where an order 0 is progressive scanning from left to right, an order 2 is progressive scanning from right to left, an order 3 is column-by-column scanning from top to bottom, and an order 1 is column-by-column scanning from bottom to top. The relative locations of the code blocks group and the code blocks group that is already decoded may be 16 relative locations shown in FIG. 5:

1. There is no code blocks group that is already decoded and that is adjacent to the code blocks group.

2. A code blocks group above the code blocks group has been decoded.

3. A code blocks group on the right of the code blocks group has been decoded.

4. A code blocks group below the code blocks group has been decoded.

5. A code blocks group on the left of the code blocks group has been decoded.

6. Code blocks groups above and on the right of the code blocks group have been decoded.

7. Code blocks groups below and on the right of the code blocks group have been decoded.

8. Code blocks groups on the left of and below the code blocks group have been decoded.

9. Code blocks groups on the left of and above the code blocks group have been decoded.

10. Code blocks groups above and below the code blocks group have been decoded.

11. Code blocks groups on the left and on the right of the code blocks group have been decoded.

12. Code blocks groups above, below, and on the left of the code blocks group have been decoded.

13. Code blocks groups on the left of, on the right of, and above the code blocks group have been decoded.

14. Code blocks groups above, below, and on the right of the code blocks group have been decoded.

15. Code blocks groups on the left of, on the right of, and below the code blocks group have been decoded.

16. Code blocks groups above, below, on the left of, and on the right of the code blocks group have been decoded.

The decoder 90 may further preconfigure a correspondence between the foregoing four processing orders and the foregoing 16 relative location relationships. For example, a relative location relationship 1 corresponds to the order 0, a relative location relationship 2 corresponds to the order 3, and a relative location relationship 3 corresponds to the order 2.

It can be learned from the foregoing correspondence that, a corresponding case is selected from the foregoing 16 cases for the current code blocks group when a different code blocks group processing order is given. A processing order of code blocks in the current code blocks group is subsequently determined, and then a decoding operation is performed on the code blocks in the current code blocks group according to the given code block processing order.

It should be understood that, the foregoing multiple preset modes and correspondences of the decoder 90 may be the same as preset modes and correspondences of the encoder side.

Optionally, in an embodiment, the determining unit 92 is further configured to determine, according to the first processing order, a relative location relationship between the code blocks group and a code blocks group that is already processed and that is adjacent to the code blocks group, and determine, according to the relative location relationship and a correspondence between the preset multiple candidate processing orders and the multiple location relationships, the processing order of the multiple code blocks included in the code blocks group, where the multiple location relationships are multiple relative location relationships between a currently processed code blocks group and a code blocks group that is already processed and that is adjacent to the currently processed code blocks group.

That is, both the multiple candidate processing orders of the code blocks and the correspondence between the multiple candidate processing orders and the multiple location relationships may be preset. The encoder side may determine, directly according to the preset correspondence, the processing order corresponding to the code blocks in the currently processed code blocks group when determining the processing order of the code blocks in the currently processed code blocks group, where the multiple candidate processing orders and the correspondence are similar to those in the foregoing embodiment, and details are not described herein again.

Optionally, in an embodiment, the acquiring unit 91 is further configured to decode the bitstream to obtain arranged indexes of the multiple code blocks groups, and determine the first processing order according to an arrangement order of the indexes of the multiple code blocks groups, or decode the bitstream to obtain arranged coordinates of the multiple code blocks groups, and determine the first processing order according to an arrangement order of the coordinates of the multiple code blocks groups.

After determining the processing order of the code blocks groups, the encoder side may write the processing order to the bitstream by means of indexes or coordinates, or in another manner such that when the decoder 90 performs decoding, the decoder 90 can directly acquire an encoding order of the code blocks groups during encoding. Further, there may be the following two manners.

In one manner, index numbers, for example, 0 to N−1, may be allocated to the code blocks groups in the coded image by means of line scan from left to right and from top to bottom. The N index numbers are written to the bitstream according to the optimum processing order obtained by means of calculation.

In the other manner, a horizontal coordinate value and a vertical coordinate value may be allocated to the code blocks group from left to right and from top to bottom. For example, (x, y) indicates a code block. The coded image has N code blocks groups in total if a coded image has w code blocks groups and h code blocks groups respectively in a horizontal direction and a vertical direction, where N=w*h, and value ranges of x and y are respectively 0≦x≦w−1 and 0≦y≦h−1. The N groups of coordinates may be encoded according to the optimum processing order obtained by means of calculation. For example, the N horizontal coordinate values and the N vertical coordinate values may be independently sequentially encoded using an encoding manner similar to PCM. Alternatively, the N horizontal coordinate values and the N vertical coordinate values may be encoded using an encoding manner similar to DPCM.

That is, correspondingly, the decoder 90 may learn the processing order of the code blocks groups in the foregoing two manners according to information that is written by the encoder side to the bitstream.

In this embodiment of the present disclosure, a processing order of code blocks included in each code blocks group is determined according to a first processing order that can achieve a minimum total coding cost and that is determined on an encoder side, and the decoder 90 decodes a bitstream of a target image according to the first processing order and the processing order of the code blocks in each code blocks group. In an encoding process, a spatial correlation of the target image is fully utilized, thereby improving compression efficiency during encoding.

FIG. 10 is a schematic block diagram of an encoder according to another embodiment of the present disclosure. The encoder 100 in FIG. 10 includes a processor 101 and a memory 102. The processor 101 is connected to the memory 102 using a bus system 103.

The memory 102 is configured to store instructions that make the processor 101 perform the operations of determining, according to a total coding cost of a target image, a first processing order of multiple code blocks groups included in the target image, encoding a code blocks group of the multiple code blocks groups according to the first processing order, to generate a bitstream, and writing the first processing order to the bitstream.

The encoder 100 in this embodiment of the present disclosure determines, according to a total coding cost of a target image, a first processing order of multiple code blocks groups included in the target image, and encode the multiple code blocks groups according to the first processing order such that a spatial correlation in the target image can be fully utilized, thereby improving compression efficiency during encoding.

It should be understood that, the target image in this embodiment of the present disclosure is a to-be-encoded image, or may be referred to as a coded image. The target image is divided into multiple non-overlapping code blocks groups, where the code blocks group may be equivalent to a CTU in the HEVC, or may be equivalent to a MB in the H.264/AVC, or the like. The code blocks group may continue to be divided into multiple code blocks for which coding parameters can be independently determined, where the code block may be equivalent to a CU in the HEVC, or may be equivalent to a MB in the H.264/AVC, or the like.

In addition, the encoder 100 may further include a receiver circuit 104 or the like. The processor 101 controls an operation of the encoder 100, and the processor 101 may be further referred to as a central processing unit (CPU). The memory 102 may include a read-only memory (ROM) and a random access memory (RAM), and provides an instruction and data to the processor 101. A part of the memory 102 may further include a non-volatile RAM (NVRAM). Components of the encoder 100 are coupled together using the bus system 103, where the bus system 103 not only includes a data bus, but also may further include a power bus, a control bus, a status signal bus, and the like. However, for clear description, various types of buses in the figure are marked as the bus system 103.

The methods disclosed in the embodiments of the present disclosure may be applied to the processor 101, or are implemented by the processor 101. The processor 101 may be an integrated circuit chip and has a signal processing capability. In an implementation process, steps of the foregoing methods may be performed using an integrated logic circuit of hardware in the processor 101 or an instruction in a form of software. The foregoing processor 101 may be a general purpose processor, a digital signal processor (DSP), an application-specific integrated circuit (ASIC), a field programmable gate array (FPGA), or another programmable logic device, discrete gate or transistor logic device, or discrete hardware component. The processor 101 may implement or perform methods, steps and logical block diagrams disclosed in the embodiments of the present disclosure. The general purpose processor may be a microprocessor or the processor may be any conventional processor and the like. Steps of the methods disclosed with reference to the embodiments of the present disclosure may be directly performed and completed by means of a hardware decoding processor, or may be performed and completed using a combination of hardware and software modules in a decoding processor. The software module may be located in a mature storage medium in the art, such as a RAM, a flash memory, a ROM, a programmable ROM (PROM), an electrically-erasable programmable memory, or a register. The storage medium is located in the memory 102, and the processor 101 reads information in the memory 102 and completes the steps in the foregoing methods in combination with hardware of the processor 101.

Optionally, in an embodiment, determining, according to a total coding cost of a target image, a first processing order of multiple code blocks groups included in the target image includes determining a total coding cost corresponding to each processing order of all processing orders of the multiple code blocks groups, where the total coding cost corresponding to each processing order is a sum of coding costs when the multiple code blocks groups are encoded according to each processing order, and determining that a processing order corresponding to a minimum total coding cost of the total coding costs corresponding to all the processing orders is the first processing order.

Optionally, in an embodiment, the encoding a code blocks group of the multiple code blocks groups according to the first processing order, to generate a bitstream includes determining, according to the first processing order, a processing order of multiple code blocks included in the code blocks group, and encoding the code blocks group according to the first processing order and the processing order of the multiple code blocks included in the code blocks group.

Optionally, in an embodiment, before determining, according to the first processing order, a processing order of multiple code blocks included in the code blocks group, the method further includes determining multiple candidate processing orders of the code blocks, and determining a correspondence between the multiple candidate processing orders and multiple location relationships, where the multiple location relationships are multiple relative location relationships between a currently processed code blocks group and a code blocks group that is already processed and that is adjacent to the currently processed code blocks group.

Optionally, in an embodiment, determining, according to the first processing order, a processing order of multiple code blocks included in the code blocks group includes determining, according to the first processing order, a relative location relationship between the code blocks group and a code blocks group that is already processed and that is adjacent to the code blocks group, and determining the processing order of the multiple code blocks included in the code blocks group according to the correspondence and the relative location relationship.

Optionally, in an embodiment, determining multiple candidate processing orders of the code blocks includes using preset multiple candidate processing orders of the code blocks.

Optionally, in an embodiment, determining, according to the first processing order, a processing order of multiple code blocks included in the code blocks group includes determining, according to the first processing order, a relative location relationship between the code blocks group and a code blocks group that is already processed and that is adjacent to the code blocks group, and determining, according to the relative location relationship and a correspondence between the preset multiple candidate processing orders and the multiple location relationships, the processing order of the multiple code blocks included in the code blocks group, where the multiple location relationships are multiple relative location relationships between a currently processed code blocks group and a code blocks group that is already processed and that is adjacent to the currently processed code blocks group.

Optionally, in an embodiment, writing the first processing order to the bitstream includes arranging indexes of the code blocks group according to the first processing order, and encoding the arranged indexes of the code blocks group and writing the encoded indexes to the bitstream, or arranging coordinates of the code blocks group according to the first processing order, and encoding the arranged coordinates of the code blocks group and writing the encoded coordinates to the bitstream.

Optionally, in an embodiment, a coding cost of the code blocks group includes at least one of a quantity of bits consumed to encode the code blocks group, or distortion of the code blocks group.

The encoder 100 in this embodiment of the present disclosure determines, according to a total coding cost of a target image, a first processing order of multiple code blocks groups included in the target image, and encode the multiple code blocks groups according to the first processing order such that a spatial correlation in the target image can be fully utilized, thereby improving compression efficiency during encoding.

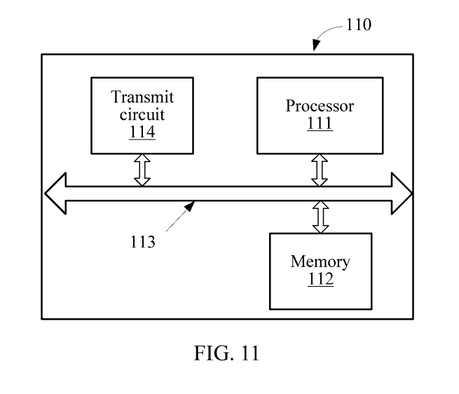

FIG. 11 is a schematic block diagram of a decoder according to another embodiment of the present disclosure. The decoder 110 in FIG. 11 includes a processor 111 and a memory 112. The processor 111 is connected to the memory 112 using a bus system 113.

The memory 112 is configured to store instructions that make the processor 111 perform the operations of acquiring a first processing order of multiple code blocks groups of a target image from a bitstream, determining, according to the first processing order, a processing order of multiple code blocks included in a code blocks group of the multiple code blocks groups, and decoding the bitstream according to the first processing order and the processing order of the multiple code blocks included in the code blocks group.

In this embodiment of the present disclosure, a processing order of code blocks included in each code blocks group is determined according to a first processing order that can achieve a minimum total coding cost and that is determined on an encoder side, and the decoder 110 decodes a bitstream of a target image according to the first processing order and the processing order of the code blocks in each code blocks group. In an encoding process, a spatial correlation of the target image is fully utilized, thereby improving compression efficiency during encoding.

In addition, the decoder 110 may further include a transmit circuit 114 or the like. The processor 111 controls an operation of the decoder 110, and the processor 111 may be further referred to as a CPU. The memory 112 may include a ROM and a RAM, and provides an instruction and data to the processor 111. A part of the memory 112 may further include an NVRAM. Components of the decoder 110 are coupled together using the bus system 113, where the bus system 113 not only includes a data bus, but also may further include a power bus, a control bus, a status signal bus, and the like. However, for clear description, various types of buses in the figure are marked as the bus system 113.

The methods disclosed in the embodiments of the present disclosure may be applied to the processor 111, or are implemented by the processor 111. The processor 111 may be an integrated circuit chip and has a signal processing capability. In an implementation process, steps of the foregoing methods may be performed using an integrated logic circuit of hardware in the processor 111 or an instruction in a form of software. The foregoing processor 111 may be a general purpose processor, a DSP, an ASIC, an FPGA, or another programmable logic device, discrete gate or transistor logic device, or discrete hardware component. The processor 111 may implement or perform methods, steps and logical block diagrams disclosed in the embodiments of the present disclosure. The general purpose processor may be a microprocessor or the processor may be any conventional processor and the like. Steps of the methods disclosed with reference to the embodiments of the present disclosure may be directly performed and completed by means of a hardware decoding processor, or may be performed and completed using a combination of hardware and software modules in a decoding processor. The software module may be located in a mature storage medium in the art, such as a RAM, a flash memory, a ROM, a PROM, an electrically-erasable programmable memory, or a register. The storage medium is located in the memory 112, and the processor 111 reads information in the memory 112 and completes the steps in the foregoing methods in combination with hardware of the processor 111.

Optionally, in an embodiment, before determining, according to the first processing order, a processing order of multiple code blocks included in a code blocks group of the multiple code blocks groups, the method further includes determining multiple candidate processing orders of the code blocks, and determining a correspondence between the multiple candidate processing orders and multiple location relationships, where the multiple location relationships are multiple relative location relationships between a currently processed code blocks group and a code blocks group that is already processed and that is adjacent to the currently processed code blocks group.

Optionally, in an embodiment, determining, according to the first processing order, a processing order of multiple code blocks included in a code blocks group of the multiple code blocks groups includes determining, according to the first processing order, a relative location relationship between the code blocks group and a code blocks group that is already processed and that is adjacent to the code blocks group, and determining, according to the correspondence and the relative location relationship, the processing order of the multiple code blocks included in the code blocks group.

Optionally, in an embodiment, determining multiple candidate processing orders of the code blocks includes using preset multiple candidate processing orders of the code blocks.

Optionally, in an embodiment, determining, according to the first processing order, a processing order of multiple code blocks included in the code blocks group includes determining, according to the first processing order, a relative location relationship between the code blocks group and a code blocks group that is already processed and that is adjacent to the code blocks group, and determining, according to the relative location relationship and a correspondence between the preset multiple candidate processing orders and the multiple location relationships, the processing order of the multiple code blocks included in the code blocks group, where the multiple location relationships are multiple relative location relationships between a currently processed code blocks group and a code blocks group that is already processed and that is adjacent to the currently processed code blocks group.

Optionally, in an embodiment, acquiring a first processing order of multiple code blocks groups of a target image from a bitstream includes decoding the bitstream to obtain arranged indexes of the multiple code blocks groups, and determining the first processing order according to an arrangement order of the indexes of the multiple code blocks groups, or decoding the bitstream to obtain arranged coordinates of the multiple code blocks groups, and determining the first processing order according to an arrangement order of the coordinates of the multiple code blocks groups.

In this embodiment of the present disclosure, a processing order of code blocks included in each code blocks group is determined according to a first processing order that can achieve a minimum total coding cost and that is determined on an encoder side, and the decoder 110 decodes a bitstream of a target image according to the first processing order and the processing order of the code blocks in each code blocks group. In an encoding process, a spatial correlation of the target image is fully utilized, thereby improving compression efficiency during encoding.

A person of ordinary skill in the art may be aware that, in combination with the examples described in the embodiments disclosed in this specification, method steps and units may be implemented by electronic hardware, computer software, or a combination thereof. To clearly describe the interchangeability between the hardware and the software, the foregoing has generally described steps and compositions of each embodiment according to functions. Whether the functions are performed by hardware or software depends on particular applications and design constraint conditions of the technical solutions. A person of ordinary skill in the art may use different methods to implement the described functions for each particular application, but it should not be considered that the implementation goes beyond the scope of the present disclosure.

Methods or steps described in the embodiments disclosed in this specification may be implemented by hardware, a software program executed by a processor, or a combination thereof. The software program may reside in a RAM, a memory, a ROM, an electrically programmable ROM, an electrically erasable programmable ROM, a register, a hard disk, a removable disk, a compact disc-ROM (CD-ROM), or any other form of storage medium known in the art.

The present disclosure is described in detail with reference to the accompany drawings and in combination with the exemplary embodiments, but the present disclosure is not limited thereto. Various equivalent modifications or replacements can be made to the embodiments of the present disclosure by a person of ordinary skill in the art without departing from the spirit and essence of the present disclosure, and the modifications or replacements shall fall within the scope of the present disclosure.

What is claimed is:

1. An encoding method, comprising:
determining, according to a total coding cost of a target image, a first processing order of multiple code blocks groups comprised in the target image;
encoding a code blocks group of the multiple code blocks groups according to the first processing order, to generate a bitstream; and
writing the first processing order to the bitstream.

2. The method according to claim 1, wherein determining, according to the total coding cost of the target image, the first processing order of multiple code blocks groups comprised in the target image comprises:
determining a total coding cost corresponding to each processing order of all processing orders of the multiple code blocks groups, wherein the total coding cost corresponding to each processing order is a sum of coding costs when the multiple code blocks groups are encoded according to each processing order; and
determining that a processing order corresponding to a minimum total coding cost of the total coding costs corresponding to all the processing orders as the first processing order.

3. The method according to claim 1, wherein encoding the code blocks group of the multiple code blocks groups according to the first processing order, to generate the bitstream comprises:
determining, according to the first processing order, a processing order of multiple code blocks comprised in the code blocks group; and
encoding the code blocks group according to the first processing order and the processing order of the multiple code blocks comprised in the code blocks group.

4. The method according to claim 3, wherein before determining, according to the first processing order, the processing order of the multiple code blocks comprised in the code blocks group, the method further comprises:
determining multiple candidate processing orders of the multiple code blocks; and
determining a first correspondence between the multiple candidate processing orders and multiple location relationships, wherein the multiple location relationships are multiple relative location relationships between a currently processed code blocks group and another code blocks group that is already processed and that is adjacent to the currently processed code blocks group.

5. The method according to claim 4, wherein determining, according to the first processing order, the processing order of the multiple code blocks comprised in the code blocks group comprises:
determining, according to the first processing order, a relative location relationship between the code blocks group and another code blocks group that is already processed and that is adjacent to the code blocks group; and
determining, according to the first correspondence and the relative location relationship, the processing order of the multiple code blocks comprised in the code blocks group.

6. The method according to claim 4, wherein determining the multiple candidate processing orders of the multiple code blocks comprises using preset multiple candidate processing orders of the multiple code blocks.

7. The method according to claim 6, wherein determining, according to the first processing order, the processing order of the multiple code blocks comprised in the code blocks group comprises:
determining, according to the first processing order, a relative location relationship between the code blocks group and another code blocks group that is already processed and that is adjacent to the code blocks group; and
determining, according to the relative location relationship and a second correspondence between the preset multiple candidate processing orders and the multiple location relationships, the processing order of the multiple code blocks comprised in the code blocks group, wherein the multiple location relationships are the multiple relative location relationships between the currently processed code blocks group and the other code blocks group that is already processed and that is adjacent to the currently processed code blocks group.

8. The method according to claim 1, wherein writing the first processing order to the bitstream comprises:
arranging indexes of the code blocks group according to the first processing order, encoding the arranged indexes of the code blocks group, and writing the encoded indexes to the bitstream; or
arranging coordinates of the code blocks group according to the first processing order, encoding the arranged coordinates of the code blocks group, and writing the encoded coordinates to the bitstream.

9. The method according to claim 1, wherein a coding cost of the code blocks group comprises at least one of the following:
a quantity of bits consumed to encode the code blocks group; and
a distortion of the code blocks group.

10. A decoding method, comprising:
acquiring a first processing order of multiple code blocks groups of a target image from a bitstream;
determining, according to the first processing order, a processing order of multiple code blocks comprised in a code blocks group of the multiple code blocks groups; and
decoding the bitstream according to the first processing order and the processing order of the multiple code blocks comprised in the code blocks group.

11. The method according to claim 10, wherein before determining, according to the first processing order, the processing order of the multiple code blocks comprised in the code blocks group of the multiple code blocks groups, the method further comprises:
determining multiple candidate processing orders of the multiple code blocks; and
determining a first correspondence between the multiple candidate processing orders and multiple location relationships, wherein the multiple location relationships are multiple relative location relationships between a currently processed code blocks group and another code blocks group that is already processed and that is adjacent to the currently processed code blocks group.

12. The method according to claim 11, wherein determining, according to the first processing order, the processing order of the multiple code blocks comprised in the code blocks group of the multiple code blocks groups comprises:
determining, according to the first processing order, a relative location relationship between the code blocks group and another code blocks group that is already processed and that is adjacent to the code blocks group; and
determining, according to the first correspondence and the relative location relationship, the processing order of the multiple code blocks comprised in the code blocks group.

13. The method according to claim 11, wherein determining the multiple candidate processing orders of the multiple code blocks comprises using preset multiple candidate processing orders of the multiple code blocks.

14. The method according to claim 13, wherein determining, according to the first processing order, the processing order of the multiple code blocks comprised in the code blocks group comprises:
determining, according to the first processing order, a relative location relationship between the code blocks group and another code blocks group that is already processed and that is adjacent to the code blocks group; and
determining, according to the relative location relationship and a second correspondence between the preset multiple candidate processing orders and the multiple location relationships, the processing order of the multiple code blocks comprised in the code blocks group, wherein the multiple location relationships are the multiple relative location relationships between the currently processed code blocks group and the other code blocks group that is already processed and that is adjacent to the currently processed code blocks group.

15. The method according to claim 10, wherein acquiring the first processing order of the multiple code blocks groups of the target image from the bitstream comprises:
decoding the bitstream to obtain arranged indexes of the multiple code blocks groups, and determining the first processing order according to an arrangement order of the indexes of the multiple code blocks groups; or
decoding the bitstream to obtain arranged coordinates of the multiple code blocks groups, and determining the first processing order according to an arrangement order of the coordinates of the multiple code blocks groups.

16. An encoder, comprising:
a memory; and
a computer processor coupled to the memory and configured to:
determine, according to a total coding cost of a target image, a first processing order of multiple code blocks groups comprised in the target image;
encode a code blocks group of the multiple code blocks groups according to the determined first processing order to generate a bitstream; and
write the determined first processing order to the bitstream.

17. The encoder according to claim 16, wherein the computer processor is further configured to:
determine a total coding cost corresponding to each processing order of all processing orders of the multiple code blocks groups, wherein the total coding cost corresponding to each processing order is a sum of coding costs when the multiple code blocks groups are encoded according to each processing order; and
determine that a processing order corresponding to a minimum total coding cost of the total coding costs corresponding to all the processing orders as the first processing order.

18. The encoder according to claim 16, wherein the computer processor is further configured to:
determine, according to the first processing order, a processing order of multiple code blocks comprised in the code blocks group; and
encode the code blocks group according to the first processing order and the processing order of the multiple code blocks comprised in the code blocks group.

19. The encoder according to claim 18, wherein the computer processor is further configured to:
determine multiple candidate processing orders of the multiple code blocks; and
determine a first correspondence between the multiple candidate processing orders and multiple location relationships, wherein the multiple location relationships are multiple relative location relationships between a currently processed code blocks group and another code blocks group that is already processed and that is adjacent to the currently processed code blocks group.

20. The encoder according to claim 19, wherein the computer processor is further configured to:
determine, according to the first processing order, a relative location relationship between the code blocks group and another code blocks group that is already processed and that is adjacent to the code blocks group; and
determine, according to the first correspondence and the relative location relationship, the processing order of the multiple code blocks comprised in the code blocks group.

21. The encoder according to claim 19, wherein the computer processor is further configured to use preset multiple candidate processing orders of the multiple code blocks.

22. The encoder according to claim 21, wherein the computer processor is further configured to:
determine, according to the first processing order, a relative location relationship between the code blocks group and another code blocks group that is already processed and that is adjacent to the code blocks group; and
determine, according to the relative location relationship and a second correspondence between the preset multiple candidate processing orders and the multiple location relationships, the processing order of the multiple code blocks comprised in the code blocks group, wherein the multiple location relationships are the multiple relative location relationships between the currently processed code blocks group and the other code blocks group that is already processed and that is adjacent to the currently processed code blocks group.

23. The encoder according to claim 16, wherein the computer processor is further configured to:
arrange indexes of the code blocks group according to the first processing order, encode the arranged indexes of the code blocks group, and write the encoded indexes to the bitstream; or
arrange coordinates of the code blocks group according to the first processing order, encode the arranged coordinates of the code blocks group, and write the encoded coordinates to the bitstream.

24. The encoder according to claim 16, wherein a coding cost of the code blocks group comprises at least one of the following:
a quantity of bits consumed to encode the code blocks group; and
a distortion of the code blocks group.

25. A decoder, comprising:
a receiver; and
a computer processor coupled to the receiver,
wherein the receiver is configured to acquire a first processing order of multiple code blocks groups of a target image from a bitstream, and
wherein the computer processor is configured to:
determine, according to the first processing order, a processing order of multiple code blocks comprised in a code blocks group of the multiple code blocks groups; and
decode the bitstream according to the first processing order and the processing order of the multiple code blocks comprised in the code blocks group.

26. The decoder according to claim 25, wherein the computer processor is further configured to:
determine multiple candidate processing orders of the multiple code blocks; and
determine a first correspondence between the multiple candidate processing orders and multiple location relationships, wherein the multiple location relationships are multiple relative location relationships between a currently processed code blocks group and another code blocks group that is already processed and that is adjacent to the currently processed code blocks group.

27. The decoder according to claim 26, wherein the computer processor is further configured to:
determine, according to the first processing order, a relative location relationship between the code blocks group and another code blocks group that is already processed and that is adjacent to the code blocks group; and
determine, according to the first correspondence and the relative location relationship, the processing order of the multiple code blocks comprised in the code blocks group.

28. The decoder according to claim 26, wherein the computer processor is further configured to use preset multiple candidate processing orders of the multiple code blocks.

29. The decoder according to claim 28, wherein the computer processor is further configured to:
determine, according to the first processing order, a relative location relationship between the code blocks group and another code blocks group that is already processed and that is adjacent to the code blocks group; and
determine, according to the relative location relationship and a second correspondence between the preset multiple candidate processing orders and the multiple location relationships, the processing order of the multiple code blocks comprised in the code blocks group, wherein the multiple location relationships are the multiple relative location relationships between the currently processed code blocks group and the other code blocks group that is already processed and that is adjacent to the currently processed code blocks group.

30. The decoder according to claim 25, wherein the receiver is further configured to:
use the computer processor to decode the bitstream to obtain arranged indexes of the multiple code blocks groups, and use the computer processor to determine the first processing order according to an arrangement order of the indexes of the multiple code blocks groups; or
use the computer processor to decode the bitstream to obtain arranged coordinates of the multiple code blocks groups, and use the computer processor to determine the first processing order according to an arrangement order of the coordinates of the multiple code blocks groups.
